(19) United States
(12) Patent Application Publication
(10) Pub. No.: US 2024/0311648 A1
(43) Pub. Date: Sep. 19, 2024

(54) MODEL TRAINING METHOD AND RELATED APPARATUS

(71) Applicant: HUAWEI TECHNOLOGIES CO., LTD., Shenzhen (CN)

(72) Inventors: Yunfei Qiao, Hangzhou (CN); Rong Li, Boulogne Billancourt (FR); Jian Wang, Hangzhou (CN)

(21) Appl. No.: 18/669,247

(22) Filed: May 20, 2024

Related U.S. Application Data
(63) Continuation of application No. PCT/CN2022/133214, filed on Nov. 21, 2022.

(30) Foreign Application Priority Data
Nov. 22, 2021 (CN) 202111386640.7

(51) Int. Cl. G06N 3/098

(52) U.S. Cl. CPC G06N 3/098

(57) ABSTRACT

This application provides a model training method and a related apparatus. In the method, a second communication apparatus receives a first neural network parameter of a first communication apparatus, and sends first indication information to the first communication apparatus when a correlation coefficient between the first neural network parameter and a second neural network parameter of the second communication apparatus is less than a first threshold. The first indication information indicates that the second communication apparatus is to participate in training of a first neural network model of the first communication apparatus. That the correlation coefficient between the first neural network parameter and the second neural network parameter is less than the first threshold indicates that the second neural network parameter makes a great contribution to convergence of the first neural network model.

### CROSS-REFERENCE TO RELATED APPLICATIONS

This application is a continuation of International Application No. PCT/CN2022/133214, filed on Nov. 21, 2022, which claims priority to Chinese Patent Application No. 202111386640.7, filed on Nov. 22, 2021. The disclosures of the aforementioned applications are hereby incorporated by reference in their entireties.

### TECHNICAL FIELD

This application relates to the neural network field, and in particular, to a model training method and a related apparatus.

### BACKGROUND

3GPP introduces an artificial intelligence (artificial intelligence, AI) capability by newly adding a network data analysis function (network data analysis function, NWDAF) to a 5th generation mobile communication (5th generation mobile communication, 5G) network. The NWDAF is responsible for AI model training. An AI model trained by the NWDAF may be used in network fields such as mobility management, session management, and network automation.

Currently, federated learning (federated learning, FL) is usually used for the AI model training. In the FL, when participating in each round of training of a central node, each distributed node needs to send a local neural network model updated in a previous round to the central node. Then, the central node combines neural network models of distributed nodes to obtain a global neural network model. If the global neural network model does not converge, the central node broadcasts the global neural network model to the distributed nodes. Each distributed node updates a local neural network model based on the global neural network model, and then uses the updated local neural network model to participate in a next round of training of a neural network model of the central node.

However, after a plurality of rounds of training, contributions of local neural network models of some distributed nodes to convergence of the global neural network model gradually reduce. In this case, if the neural network models of these distributed nodes continue to participate in the training of the neural network model of the central node, signaling overheads are wasted.

### SUMMARY

Embodiments of this application provide a model training method and a related apparatus, to reduce signaling overheads.

According to a first aspect, an embodiment of this application provides a model training method. In the method, a second communication apparatus receives a first neural network parameter of a first communication apparatus, and sends first indication information to the first communication apparatus when a correlation coefficient between the first neural network parameter and a second neural network parameter of the second communication apparatus is less than a first threshold. The first indication information indicates that the second communication apparatus is to participate in training of a first neural network model of the first communication apparatus.

In this embodiment of this application, that the correlation coefficient between the first neural network parameter and the second neural network parameter is less than the first threshold indicates that the second neural network parameter makes a great contribution to convergence of the first neural network model. Therefore, the second communication apparatus determines, based on a contribution of the second neural network parameter to the convergence of the first neural network model, whether to participate in the training of the first neural network model. This can prevent the second communication apparatus from still participating in the training of the first neural network model when the second neural network parameter makes a small contribution to the convergence of the first neural network model, so that signaling overheads of the second communication apparatus can be reduced.

In an optional implementation, the first neural network parameter is a model parameter of a first neural network or a gradient of the first neural network, and the second neural network parameter is a model parameter of a second neural network or a gradient of the second neural network.

In other words, the first neural network parameter is the model parameter of the first neural network, and the second neural network parameter is the model parameter of the second neural network. Optionally, the first neural network parameter is a gradient of a neural network of the first communication apparatus, and the second neural network parameter is a gradient of a neural network of the second communication apparatus. Therefore, the second communication apparatus determines the correlation coefficient between the first neural network parameter and the second neural network parameter based on a type to which the received first neural network parameter belongs.

In an optional implementation, the first neural network parameter is received on a cooperation discover resource, and the cooperation discover resource is configured in sidelink configuration information. In other words, the second communication apparatus receives the first neural network parameter from the first communication apparatus by using the cooperation discover resource in the sidelink configuration information.

In an optional implementation, when the foregoing correlation coefficient is less than the first threshold, the second communication apparatus may further send the second neural network parameter to the first communication apparatus, to enable the first communication apparatus to update the first neural network model based on the second neural network parameter. Therefore, the first communication apparatus updates the first neural network model by using the second neural network parameter that has a great contribution to the convergence of the first neural network model. This facilitates accelerating the convergence of the first neural network model.

In an optional implementation, the second communication apparatus may further receive a control signal from the first communication apparatus. The control signal indicates a time-frequency resource, and the indicated time-frequency resource is used by the second communication apparatus to send the second neural network parameter. It can be learned that the second communication apparatus learns of, by receiving the control signal from the first communication apparatus, the time-frequency resource for sending the second neural network parameter to the first communication apparatus, so that the second communication apparatus may send the second neural network parameter on the time-frequency resource.

In an optional implementation, a resource for receiving the control signal is a cooperation control resource, and the cooperation control resource is configured in the foregoing sidelink configuration information. In other words, the second communication apparatus receives the foregoing control signal by using the cooperation control resource in the sidelink configuration information.

In an optional implementation, the second communication apparatus may further receive a synchronization signal on a cooperation synchronization resource, and perform synchronization with the first communication apparatus based on the synchronization signal. Therefore, after performing the synchronization with the first communication apparatus, the second communication apparatus may communicate with the first communication apparatus. The cooperation synchronization resource may be configured in the foregoing sidelink configuration information.

In an optional implementation, the cooperation discover resource, the cooperation control resource, and the cooperation synchronization resource configured in the foregoing sidelink configuration information may be preconfigured, may be dynamically indicated, or may be unlicensed spectrum resources.

In an optional implementation, when the first neural network parameter is the model parameter of the first neural network, and the second neural network parameter is the model parameter of the second neural network, the foregoing correlation coefficient between the first neural network parameter and the second neural network parameter is determined based on a first parameter and a second parameter.

The first parameter is a parameter output by the first neural network model when the second communication apparatus inputs training data into the first neural network model. The first neural network model is determined based on the model parameter of the first neural network. The second parameter is a parameter output by a second neural network model of the second communication apparatus when the second communication apparatus inputs the training data into the second neural network model. In other words, the first parameter and the second parameter are parameters that are respectively output by the first neural network model and the second neural network model when the second communication apparatus separately inputs same training data into the first neural network model and the second neural network model.

In another optional implementation, when the first neural network parameter is the gradient of the first neural network, and the second neural network parameter is the gradient of the second neural network, the correlation coefficient between the first neural network parameter and the second neural network parameter is determined based on probability density distribution of the first neural network parameter and probability density distribution of the second neural network parameter.

It can be learned that the second communication apparatus may flexibly determine the correlation coefficient between the first neural network parameter and the second neural network parameter in a corresponding manner based on a type to which the received first neural network parameter belongs.

According to a second aspect, this application further provides a model training method. The model training method in this aspect corresponds to the model training method in the first aspect, and the model training method in this aspect is described from a first communication apparatus side. In the method, a first communication apparatus sends a first neural network parameter of the first communication apparatus. The first communication apparatus receives first indication information from a second communication apparatus. The first indication information is sent by the second communication apparatus when a correlation coefficient between the first neural network parameter and a second neural network parameter of the second communication apparatus is less than a first threshold. The first indication information indicates that the second communication apparatus is to participate in training of a first neural network model of the first communication apparatus.

It can be learned that in this embodiment of this application, the first indication information received by the first communication apparatus is sent by the second communication apparatus when the correlation coefficient between the first neural network parameter and the second neural network parameter is less than the first threshold. Therefore, the second communication apparatus determines, based on a contribution of the second neural network parameter to convergence of the first neural network model, whether to participate in the training of the first neural network model. In this way, the first communication apparatus subsequently does not update the first neural network model based on second neural network parameters of all second communication apparatuses, but updates the first neural network model based on a second neural network parameter that makes a greater contribution to the convergence of the first neural network model, so that signaling overheads of the first communication apparatus can be reduced.

In an optional implementation, the first neural network parameter is a model parameter of a first neural network or a gradient of the first neural network, and the second neural network parameter is a model parameter of a second neural network or a gradient of the second neural network.

The first neural network parameter is the model parameter of the first neural network, and the second neural network parameter is the model parameter of the second neural network. Optionally, the first neural network parameter is a gradient of a neural network of the first communication apparatus, and the second neural network parameter is a gradient of a neural network of the second communication apparatus.

In an optional implementation, the first neural network parameter is sent on a cooperation discover resource, and the cooperation discover resource is configured in sidelink configuration information. In other words, the first communication apparatus sends the first neural network parameter to the first communication apparatus by using the cooperation discover resource in the sidelink configuration information.

In an optional implementation, the first communication apparatus may further receive the second neural network parameter from the second communication apparatus, and update the first neural network model based on the second neural network parameter. It can be learned that the first communication apparatus updates the first neural network model based on the second neural network parameter of the second communication apparatus that feeds back the first indication information, so that the signaling overheads of the first communication apparatus can be reduced.

In an optional implementation, the first communication apparatus may further send a control signal to the second communication apparatus. The control signal indicates a time-frequency resource, and the indicated time-frequency resource is used by the second communication apparatus to send the second neural network parameter. It can be learned that the first communication apparatus indicates, to the second communication apparatus by using the control signal, the time-frequency resource for sending the second neural network parameter. This facilitates that the second communication apparatus sends the second neural network parameter by using the time-frequency resource.

In an optional implementation, a resource for sending the control signal is a cooperation control resource, and the cooperation control resource is configured in the foregoing sidelink configuration information. In other words, the first communication apparatus sends the foregoing control signal by using the cooperation control resource in the sidelink configuration information.

In an optional implementation, the first communication apparatus may further send a synchronization signal on a cooperation synchronization resource, to enable the second communication apparatus to perform synchronization with the first communication apparatus based on the synchronization signal. In addition, the cooperation synchronization resource may be configured in the foregoing sidelink configuration information.

In an optional implementation, the cooperation discover resource, the cooperation control resource, and the cooperation synchronization resource configured in the foregoing sidelink configuration information may be preconfigured, may be dynamically indicated, or may be unlicensed spectrum resources.

According to a third aspect, this application further provides a model training method. In the method, a first communication apparatus sends cooperation request information. The cooperation request information includes a plurality of training tasks, and the plurality of training tasks are obtained by splitting a to-be-trained neural network model by the first communication apparatus. The first communication apparatus receives second indication information from a second communication apparatus. The second indication information indicates that the second communication apparatus is to participate in training of a first training task, and the first training task is one or more of the plurality of training tasks.

It can be learned that in this embodiment of this application, the first communication apparatus splits the to-be-trained neural network model into a plurality of training tasks, and broadcasts the plurality of training tasks to surrounding second communication apparatuses by using the cooperation request information, to request the second communication apparatuses to participate in training of the plurality of training tasks. The first communication apparatus learns of, by receiving the second indication information, a training task that the second communication apparatus can participate in. In this manner, the first communication apparatus learns that the surrounding second communication apparatus assists in participating in training of the to-be-trained neural network model, so that a requirement on a capability of the first communication apparatus can be reduced.

In an optional implementation, the foregoing cooperation request information is sent on a cooperation discover resource, and the cooperation discover resource is configured in sidelink configuration information. It can be learned that the first communication apparatus sends the cooperation request information by using the cooperation discover resource in the sidelink configuration information.

In an optional implementation, the first training task indicated by the second indication information sent by the second communication apparatus includes a plurality of training tasks. In this case, the first communication apparatus may further send third indication information. The third indication information indicates one training task in the first training task.

It may be understood that the first communication apparatus determines the third indication information based on a training task indicated by each piece of received second indication information, to ensure that a training task trained by each second communication apparatus that participates in training is not repeated.

In another optional implementation, first training tasks indicated by second indication information sent by a plurality of second communication apparatuses are same training tasks in the plurality of training tasks. In this case, the first communication apparatus may alternatively indicate, to one of the second communication apparatuses by using the third indication information, a training task in which the second communication apparatus participates in training. Therefore, a second communication apparatus that receives the third indication information learns of a training task that needs to be trained, and a second communication apparatus that does not receive the third indication information does not participate in the training.

In an optional implementation, the first communication apparatus may further send fourth indication information to the second communication apparatus. The fourth indication information indicates a first output that needs to be received by the second communication apparatus, and a time-frequency resource location corresponding to the first output, and/or a second output that needs to be sent by the second communication apparatus, and a time-frequency resource location corresponding to the second output. The first output is an output of a neural network model trained by the first communication apparatus, or an output of a neural network model trained by a second communication apparatus other than the second communication apparatus, and the second output is an output of a neural network model trained by the second communication apparatus.

It can be learned that the first communication apparatus notifies, by using the fourth indication information, the second communication apparatus participating in the training of a parameter that needs to be received, a time-frequency resource location corresponding to the parameter that needs to be received, and/or a parameter that needs to be sent, and a time-frequency resource location corresponding to the parameter that needs to be sent. This facilitates that any second communication apparatus participating in the training receives and/or sends a corresponding output in a training process of a training task, to ensure cooperative training of other second communication apparatuses.

In an optional implementation, a resource for sending the fourth indication information is a cooperation control resource, and the cooperation control resource is configured in the sidelink configuration information. It can be learned that the first communication apparatus sends the fourth indication information by using the cooperation control resource in the sidelink configuration information.

In an optional implementation, the first communication apparatus may further send a synchronization signal on a cooperation synchronization resource, to enable the second communication apparatus to perform synchronization with the first communication apparatus based on the synchronization signal. In addition, the cooperation synchronization resource is configured in the sidelink configuration information.

In an optional implementation, the cooperation discover resource, the cooperation control resource, and the cooperation synchronization resource configured in the foregoing sidelink configuration information may be preconfigured, may be dynamically indicated, or may be unlicensed spectrum resources.

According to a fourth aspect, this application further provides a model training method. The model training method in this aspect corresponds to the model training method in the third aspect, and the model training method in this aspect is described from a second communication apparatus side. In the method, a second communication apparatus receives cooperation request information. The cooperation request information includes a plurality of training tasks, and the plurality of training tasks are obtained by splitting a to-be-trained neural network model by a first communication apparatus. The second communication apparatus sends second indication information when determining to participate in training of a first training task. The second indication information indicates that the second communication apparatus is to participate in the training of the first training task, and the first training task is one or more of the plurality of training tasks.

It can be learned that in this embodiment of this application, when determining to participate in the training of the first training task in the plurality of training tasks requested by the first communication apparatus, the second communication apparatus sends indication information indicating that the second communication apparatus is to participate in the first training task, to notify the first communication apparatus that the second communication apparatus can assist the first communication apparatus in participating in the training of the first training task. This facilitates reducing a requirement on a capability of the first communication apparatus.

In an optional implementation, the cooperation request information is received on a cooperation discover resource, and the cooperation discover resource is configured in sidelink configuration information. It can be learned that the second communication apparatus receives the cooperation request information by using the cooperation discover resource in the sidelink configuration information.

In an optional implementation, the second communication apparatus may further receive third indication information. The third indication information indicates one training task in the first training task, so that the second communication apparatus learns of a training task that is participated in training.

In an optional implementation, the second communication apparatus may further receive fourth indication information. The fourth indication information indicates a first output to be received by the second communication apparatus and a time-frequency resource location corresponding to the first output, and/or a second output to be sent by the second communication apparatus and a time-frequency resource location corresponding to the second output. The first output is an output of a neural network model trained by the first communication apparatus, or an output of a neural network model trained by a second communication apparatus other than the second communication apparatus, and the second output is an output of a neural network model trained by the second communication apparatus. Therefore, the second communication apparatus receives and/or sends a corresponding output in a training process of a training task, to ensure cooperative training of other second communication apparatuses.

In an optional implementation, a resource for receiving the fourth indication information is a cooperation control resource, and the cooperation control resource is configured in the sidelink configuration information. It can be learned that the second communication apparatus receives the fourth indication information by using the cooperation control resource in the sidelink configuration information.

In an optional implementation, the second communication apparatus may further receive a synchronization signal on a cooperation synchronization resource, and perform synchronization with the first communication apparatus based on the synchronization signal. Therefore, after performing the synchronization with the first communication apparatus, the second communication apparatus may communicate with the first communication apparatus. In addition, the cooperation synchronization resource is configured in the foregoing sidelink configuration information.

In an optional implementation, the cooperation discover resource, the cooperation control resource, and the cooperation synchronization resource configured in the foregoing sidelink configuration information may be preconfigured, may be dynamically indicated, or may be unlicensed spectrum resources.

According to a fifth aspect, this application further provides a communication apparatus. The communication apparatus has some or all functions of implementing the second communication apparatus according to the first aspect, has some or all functions of implementing the first communication apparatus according to the second aspect, has some or all functions of implementing the first communication apparatus according to the third aspect, or has some or all functions of implementing the second communication apparatus according to the fourth aspect. For example, functions of the communication apparatus may have functions of the second communication apparatus according to some or all embodiments of the first aspect of this application, or may have functions of independently implementing any embodiment of this application. The functions may be implemented by hardware, or may be implemented by hardware executing corresponding software. The hardware or the software includes one or more units or modules corresponding to the foregoing functions.

In a possible design, a structure of the communication apparatus may include a processing unit and a communication unit. The processing unit is configured to support the communication apparatus in performing a corresponding function in the foregoing method. The communication unit is configured to support communication between the communication apparatus and another communication apparatus. The communication apparatus may further include a storage unit. The storage unit is configured to be coupled to the processing unit and the communication unit, and the storage unit stores program instructions and data that are necessary for the communication apparatus.

In an implementation, the communication apparatus includes a processing unit and a communication unit. The processing unit is configured to control the communication unit to receive and send data/signaling. The communication unit is configured to receive a first neural network parameter of a first communication apparatus. The communication unit is further configured to send first indication information to the first communication apparatus when a correlation coefficient between the first neural network parameter and a second neural network parameter of the communication apparatus is less than a first threshold. The first indication information indicates that the communication apparatus is to participate in training of a first neural network model of the first communication apparatus.

In addition, for another optional implementation of the communication apparatus in this aspect, refer to related content of the first aspect. Details are not described herein again.

In another implementation, the communication apparatus includes a processing unit and a communication unit. The processing unit is configured to control the communication unit to receive and send data/signaling. The communication unit is configured to send a first neural network parameter of the communication apparatus. The communication unit is further configured to receive first indication information from a second communication apparatus. The first indication information is sent by the second communication apparatus when a correlation coefficient between the first neural network parameter and a second neural network parameter of the second apparatus is less than a first threshold. The first indication information indicates that the second communication apparatus is to participate in training of a first neural network model of the communication apparatus.

In addition, for another optional implementation of the communication apparatus in this aspect, refer to related content of the second aspect. Details are not described herein again.

In still another implementation, the communication apparatus includes a processing unit and a communication unit. The processing unit is configured to control the communication unit to receive and send data/signaling. The communication unit is configured to send cooperation request information. The cooperation request information includes a plurality of training tasks, and the plurality of training tasks are obtained by splitting a to-be-trained neural network model by the first communication apparatus. The communication unit is further configured to receive second indication information from a second communication apparatus. The second indication information indicates that the second communication apparatus is to participate in training of a first training task, and the first training task is one or more of the plurality of training tasks.

In addition, for another optional implementation of the communication apparatus in this aspect, refer to related content of the third aspect. Details are not described herein again.

In yet another implementation, the communication apparatus includes a processing unit and a communication unit. The processing unit is configured to control the communication unit to receive and send data/signaling. The communication unit is configured to receive cooperation request information. The cooperation request information includes a plurality of training tasks, and the plurality of training tasks are obtained by splitting a to-be-trained neural network model by a first communication apparatus. The communication unit is further configured to send second indication information when determining to participate in training of a first training task. The second indication information indicates that the second communication apparatus is to participate in the training of the first training task, and the first training task is one or more of the plurality of training tasks.

In addition, for another optional implementation of the communication apparatus in this aspect, refer to related content of the fourth aspect. Details are not described herein again.

In an example, the communication unit may be a transceiver or a communication interface, the storage unit may be a memory, and the processing unit may be a processor.

In an implementation, the communication apparatus includes a processor and a transceiver. The processor is configured to control the transceiver to receive and send data/signaling. The transceiver is configured to receive a first neural network parameter of a first communication apparatus. The transceiver is further configured to send first indication information to the first communication apparatus when a correlation coefficient between the first neural network parameter and a second neural network parameter of the communication apparatus is less than a first threshold. The first indication information indicates that the communication apparatus is to participate in training of a first neural network model of the first communication apparatus.

In addition, for another optional implementation of the communication apparatus in this aspect, refer to related content of the first aspect. Details are not described herein again.

In another implementation, the communication apparatus includes a processor and a transceiver. The processor is configured to control the transceiver to receive and send data/signaling. The transceiver is configured to send a first neural network parameter of the communication apparatus. The transceiver is further configured to receive first indication information from a second communication apparatus. The first indication information is sent by the second communication apparatus when a correlation coefficient between the first neural network parameter and a second neural network parameter of the second apparatus is less than a first threshold. The first indication information indicates that the second communication apparatus is to participate in training of a first neural network model of the communication apparatus.

In addition, for another optional implementation of the communication apparatus in this aspect, refer to related content of the second aspect. Details are not described herein again.

In still another implementation, the communication apparatus includes a processor and a transceiver. The processor is configured to control the transceiver to receive and send data/signaling. The transceiver is configured to send cooperation request information. The cooperation request information includes a plurality of training tasks, and the plurality of training tasks are obtained by splitting a to-be-trained neural network model by the first communication apparatus. The transceiver is further configured to receive second indication information from a second communication apparatus. The second indication information indicates that the second communication apparatus is to participate in training of a first training task, and the first training task is one or more of the plurality of training tasks.

In addition, for another optional implementation of the communication apparatus in this aspect, refer to related content of the third aspect. Details are not described herein again.

In yet another implementation, the communication apparatus includes a processor and a transceiver. The processor is configured to control the transceiver to receive and send data/signaling. The transceiver is configured to receive cooperation request information. The cooperation request information includes a plurality of training tasks, and the plurality of training tasks are obtained by splitting a to-be-trained neural network model by a first communication apparatus. The transceiver is further configured to send second indication information when determining to participate in training of a first training task. The second indication information indicates that the second communication apparatus is to participate in the training of the first training task, and the first training task is one or more of the plurality of training tasks.

In addition, for another optional implementation of the communication apparatus in this aspect, refer to related content of the fourth aspect. Details are not described herein again.

In another implementation, the communication apparatus is a chip or a chip system. The processing unit may also be represented as a processing circuit or a logic circuit. The transceiver unit may be an input/output interface, an interface circuit, an output circuit, an input circuit, a pin, a related circuit, or the like on the chip or the chip system.

In an implementation process, the processor may be configured to perform, for example, but not limited to, baseband-related processing, and the transceiver may be configured to perform, for example, but not limited to, radio frequency receiving and sending. The foregoing components may be separately disposed on chips that are independent of each other, or at least some or all of the components may be disposed on a same chip. For example, the processor may be further divided into an analog baseband processor and a digital baseband processor. The analog baseband processor and the transceiver may be integrated on a same chip, and the digital baseband processor may be disposed on an independent chip. With continuous development of an integrated circuit technology, increasingly more components may be integrated on a same chip. For example, the digital baseband processor and a plurality of application processors (for example, but not limited to, a graphics processing unit and a multimedia processor) may be integrated on a same chip. Such a chip may be referred to as a system on a chip (system on a chip, SoC). Whether the components are independently disposed on different chips or are integrated on one or more chips usually depends on a requirement of a product design. This embodiment of this application imposes no limitation on specific implementations of the foregoing components.

According to a sixth aspect, this application further provides a processor, configured to perform the foregoing methods. In a process of performing these methods, a process of sending the foregoing information and a process of receiving the foregoing information in the foregoing methods may be understood as a process of outputting the foregoing information by the processor and a process of receiving the foregoing input information by the processor. When outputting the foregoing information, the processor outputs the foregoing information to a transceiver, so that the transceiver transmits the information. After the foregoing information is output by the processor, other processing may further need to be performed on the information before the information arrives at the transceiver. Similarly, during receiving of the foregoing input information by the processor, the transceiver receives the foregoing information, and inputs the information to the processor. Further, after the transceiver receives the foregoing information, other processing may need to be performed on the foregoing information before the information is inputted into the processor.

Based on the foregoing principle, for example, the receiving the first neural network parameter of the first communication apparatus mentioned in the foregoing method may be understood as that the processor inputs the first neural network parameter of the first communication apparatus.

Unless otherwise specified, or if operations such as sending and receiving related to the processor do not contradict an actual function or internal logic of the operations in related descriptions, all the operations may be more generally understood as operations such as outputting, receiving, and inputting of the processor, instead of operations such as sending and receiving directly performed by a radio frequency circuit and an antenna.

In an implementation process, the foregoing processor may be a processor specially configured to perform these methods, or a processor, for example, a general-purpose processor, that executes computer instructions in a memory to perform these methods. The foregoing memory may be a non-transitory (non-transitory) memory, for example, a read-only memory (read-only memory, ROM). The memory and the processor may be integrated on a same chip, or may be separately disposed on different chips. A type of the memory and a manner of disposing the memory and the processor are not limited in this embodiment of this application.

According to a seventh aspect, this application further provides a communication system. The system includes at least one first communication apparatus and at least two second communication apparatuses in the foregoing aspects. In another possible design, the system may further include another device that interacts with the first communication apparatus and the second communication apparatus in the solutions provided in this application.

According to an eighth aspect, this application provides a computer-readable storage medium, configured to store instructions. When the instructions are executed by a computer, the method according to any one of the first aspect to the fourth aspect is implemented.

According to a ninth aspect, this application further provides a computer program product including instructions. When the computer program product is run on a computer, the method according to any one of the first aspect to the fourth aspect is implemented.

According to a tenth aspect, this application provides a chip system. The chip system includes a processor and an interface. The interface is configured to obtain a program or instructions. The processor is configured to invoke the program or the instructions to implement or support a second communication apparatus in implementing a function in the first aspect, is configured to invoke the program or the instructions to implement or support a first communication apparatus in implementing a function in the second aspect, is configured to invoke the program or the instructions to implement or support a first communication apparatus in implementing a function in the third aspect, or is configured to invoke the program or the instructions to implement or support the second communication apparatus in implementing a function in the fourth aspect, for example, determining or processing at least one of data and information in the foregoing method. In a possible design, the chip system further includes a memory. The memory is configured to store program instructions and data that are necessary for a terminal. The chip system may include a chip, or may include a chip and another discrete component.

### BRIEF DESCRIPTION OF DRAWINGS

FIG. 1 is a schematic diagram of a structure of a communication system according to an embodiment of this application;

FIG. 2 is a schematic diagram of a structure of another communication system according to an embodiment of this application;

FIG. 3 is a schematic diagram of a federated learning system according to an embodiment of this application;

FIG. 4 is a schematic diagram of split learning according to an embodiment of this application;

FIG. 5 is a schematic flowchart of interaction of a model training method according to an embodiment of this application;

FIG. 6 is a schematic flowchart of interaction of another model training method according to an embodiment of this application;

FIG. 7 is a schematic flowchart of interaction of still another model training method according to an embodiment of this application;

FIG. 8 is a schematic diagram of splitting a to-be-trained neural network model according to an embodiment of this application;

FIG. 9 is a schematic flowchart of interaction of yet another model training method according to an embodiment of this application;

FIG. 10 is a schematic diagram of a structure of a communication apparatus according to an embodiment of this application;

FIG. 11 is a schematic diagram of a structure of another communication apparatus according to an embodiment of this application; and

FIG. 12 is a schematic diagram of a structure of a chip according to an embodiment of this application.

### DESCRIPTION OF EMBODIMENTS

The following clearly and describes the technical solutions in embodiments of this application with reference to the accompanying drawings in embodiments of this application.

To better understand a model training method disclosed in embodiments of this application, a communication system to which embodiments of this application are applicable is described.

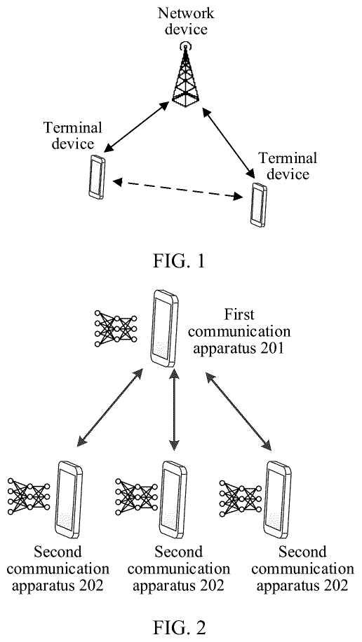

Embodiments of this application may be applied to a 5th generation mobile communication (5th generation mobile communication, 5G) system, and a wireless communication system such as a satellite communication system and a short-range wireless communication system. A system architecture is shown in FIG. 1. The wireless communication system may include one or more network devices and one or more terminal devices. The wireless communication system may alternatively perform point-to-point communication. For example, a plurality of terminal devices communicate with each other.

It may be understood that the wireless communication system mentioned in embodiments of this application includes but is not limited to a narrowband internet of things (narrowband internet of things, NB-IoT) system, a long term evolution (long term evolution, LTE) system, three application scenarios of a 5G mobile communication system, namely, enhanced mobile broadband (enhanced mobile broadband, eMBB), ultra-reliable low-latency communication (ultra-reliable low-latency communication, URLLC), and massive machine type communication (massive machine type communication, mMTC), a wireless fidelity (wireless fidelity, Wi-Fi) system, a mobile communication system after 5G, or the like.

FIG. 2 is a schematic diagram of a structure of another communication system according to an embodiment of this application. The communication system may include but is not limited to one first communication apparatus 201 and two second communication apparatuses 202. Quantities and forms of devices shown in FIG. 2 are used as examples and do not constitute a limitation on this embodiment of this application. In actual application, two or more second communication apparatuses 202 and more than three second communication apparatuses 202 may be included. The first communication apparatus may be a network device, or may be a terminal device. The second communication apparatus is a terminal device. In this embodiment of this application, an example in which both the first communication apparatus and the second communication apparatus are terminal devices is used for description.

In this embodiment of this application, the second communication apparatus is a surrounding terminal device of the first communication apparatus. In other words, each second communication apparatus and the first communication apparatus are located in a same cell. A neural network model is disposed in both the first communication apparatus and the second communication apparatus, and the second communication apparatus may cooperate with the first communication apparatus to participate in training of a first neural network model of the first communication apparatus.

In this embodiment of this application, the network device is a device having a wireless transceiver function, and is configured to communicate with a terminal device. The network device may be an evolved NodeB (evolved NodeB, eNB or eNodeB) in LTE, a base station in a 5G network or a base station in a future evolved public land mobile network (public land mobile network, PLMN), a broadband network gateway (broadband network gateway, BNG), an aggregation switch, a non-3rd generation partnership project (3rd generation partnership project, 3GPP) access device, or the like. Optionally, the network device in this embodiment of this application may include base stations in various forms, for example, a macro base station, a micro base station (also referred to as a small cell), a relay station, an access point, a device for implementing a base station function in the future, an access node in a Wi-Fi system, a transmitting and receiving point (transmitting and receiving point, TRP), a transmitting point (transmitting point, TP), a mobile switching center, and a device that functions as a base station in communication such as device-to-device (device-to-device, D2D), vehicle-to-everything (vehicle-to-everything, V2X), and machine-to-machine (machine-to-machine, M2M). This is not specifically limited in this embodiment of this application.

The network device may communicate and interact with a core network device, to provide a communication service for the terminal device. The core network device is, for example, a device in a core network (core network, CN) of a 5G network. As a bearer network, the core network provides an interface to a data network, provides communication connection, authentication, management, and policy control for a terminal, bearers a data service, and the like.

The terminal device in this embodiment of this application may include various handheld devices, vehicle-mounted devices, wearable devices, or computing devices that have a wireless communication function, or other processing devices connected to a wireless modem. The terminal device may alternatively be user equipment (user equipment, UE), an access terminal, a subscriber unit (subscriber unit), a user agent, a cellular phone (cellular phone), a smartphone (smartphone), a wireless data card, a personal digital assistant (personal digital assistant, PDA) computer, a tablet computer, a wireless modem (modem), a handheld device (handset), a laptop computer (laptop computer), a machine type communication (machine type communication, MTC) terminal, a communication device carried on a high-altitude aircraft, a wearable device, a drone, a robot, a terminal in device-to-device (device-to-device, D2D) communication, a terminal in vehicle to everything (vehicle to everything, V2X), a virtual reality (virtual reality, VR) terminal device, an augmented reality (augmented reality, AR) terminal device, a wireless terminal in industrial control (industrial control), a wireless terminal in self driving (self driving), a wireless terminal in remote medical (remote medical), a wireless terminal in a smart grid (smart grid), a wireless terminal in transportation safety (transportation safety), and a wireless terminal in a smart city (smart city), a wireless terminal in a smart home (smart home), a terminal device in a future communication network, or the like. This is not limited in this application.

For ease of understanding of embodiments disclosed in this application, the following two points are described.

(1) In embodiments disclosed in this application, a scenario of an 5G new radio (new radio, NR) network in a wireless communication network is used as an example for description. It should be noted that the solutions in embodiments disclosed in this application may be further applied to another wireless communication network, and a corresponding name may also be replaced with a name of a corresponding function in the another wireless communication network.

(2) Aspects, embodiments, or features of this application are presented in embodiments disclosed in this application by describing a system that includes a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

To better understand the model training method disclosed in embodiments of this application, related concepts in embodiments of this application are briefly described.

### 1. Federated Learning FL

The federated learning is a learning method that enables surrounding devices to cooperate with a server of a central end to efficiently complete a model while ensuring user data privacy and security. An FL algorithm is as follows.

(1) In an (i∈[1, T])^{th} round of training of the server of the central end, a terminal device m trains a local neural network model by using a local dataset, and transmits a local gradient gᵢ^{m}=(g_{i,1}^{m}, g_{i,2}^{m}, . . . , g_{i,γ}^{m})∈R^{γ,1}, m=1, 2, . . . , M to the server of the central end through an air interface. γ represents a quantity of backhauled gradient parameters, T is a threshold quantity of times, T is greater than or equal to 2, M is a total quantity of terminal devices, and g_{i,γ}^{m} represents a gradient corresponding to a γ^{th} gradient parameter of the terminal device m in an i^{th} round of training.

(2) The server of the central end summarizes and collects gradients from all (partial) terminal devices, and performs weighted averaging on the gradients to obtain a new global gradient:

$${g}_{i + 1}^{f} = ( {g}_{i + 1 , 1}^{f} , {g}_{i + 1 , 2}^{f} , … , {g}_{i + 1 , γ}^{f} ) ∈ {R}^{γ \times 1} , {g}_{i + 1}^{f} = \frac{{\sum }_{m = 1}^{m} {g}_{i}^{1 , m}}{M} .$$

(3) The central end updates a local neural network model based on the new global gradient, to obtain an updated neural network model. If the updated neural network model does not converge, and a quantity of training times does not reach a threshold, the new global gradient is broadcast to each terminal device. After receiving the new global gradient, the terminal device updates a local neural network model of the terminal device based on the new global gradient, until a neural network model at the central end converges or a quantity of training rounds reaches the threshold quantity of times.

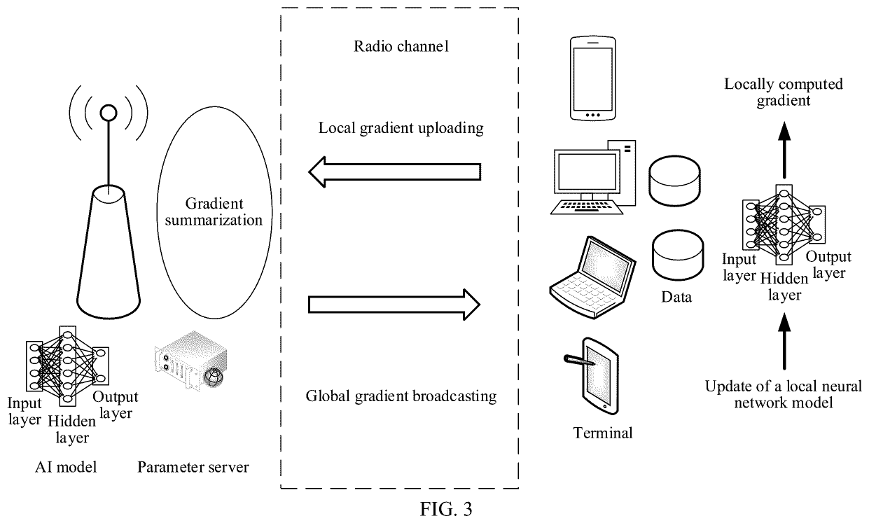

For example, a schematic diagram of a federated learning system is shown in FIG. 3. In FIG. 3, the central end is a network device, and the surrounding devices are various terminal devices. In the federated learning, each terminal device uploads a locally computed gradient to the network device through a radio channel. The network device summarizes a plurality of local gradients, to be specific, performs weighted averaging processing on the plurality of received gradients, to obtain a global gradient, and updates a local neural network model based on the global gradient. If the updated neural network model still does not converge, and a quantity of training times does not reach the threshold quantity of times, the global gradient is broadcast to each terminal device. After receiving the global gradient, any terminal device updates a neural network model of the terminal device by using the global gradient, uploads a gradient of the updated neural network model to the network device, and performs a next round of training of a neural network model, until the neural network model of the network device converges, or the quantity of training times reaches the threshold quantity of times.

### 2. Split Learning (Split Learning)

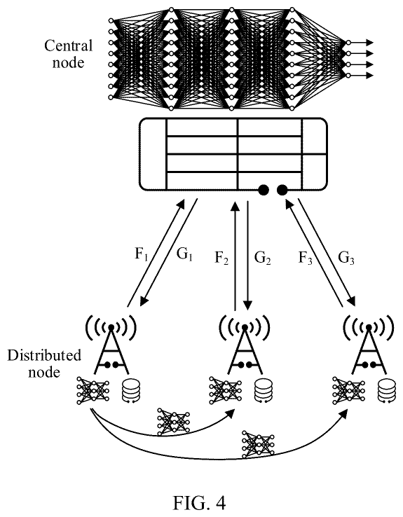

The split learning is shown in FIG. 4. In the split learning, a complete neural network model is split into two parts (that is, two subnets). One part of subnets of a neural network are deployed on a distributed node, and the other part of subnets are deployed on a central node. A place at which the complete neural network is split is referred to as a “split layer”. In a forward inference process of the neural network model, the distributed node inputs local data into a local subnet, performs inference to the split layer, and sends a result F1 of the split layer to the central node through a communication link. The central node inputs the received F1 into another subnet deployed on the central node, and continues to perform forward inference to obtain a final inference result. In gradient reverse transfer of training of the neural network model, a gradient is reversely transferred to the split layer by using a subnet of the central node, to obtain a reverse transfer result G1. Then the central node sends G1 to the distributed node, so that gradient reverse transfer continues to be performed on G1 on a subnet of the distributed node.

In the forward inference and gradient reverse transfer processes of the split learning, only one distributed node and one central node are involved. A subnet on a trained distributed node may be stored locally on the distributed node or on a specific model storage server. When a new distributed node joins a learning system, the new distributed node may first download the subnet of the trained distributed node, and then perform further training by using the local data.

It can be learned from the foregoing federated learning that, in current distributed learning, the central node summarizes local models reported by distributed nodes, performs combination processing on neural network models of the distributed nodes, and then delivers a neural network model obtained through combination processing to the distributed nodes to perform a next round of training, until a neural network model of the central node converges. However, after several rounds of training, contributions of some distributed nodes to convergence of the neural network model of the central node gradually reduce. In this case, if the distributed nodes continue to participate in training of the neural network model of the central node, a gain brought by the distributed nodes may be insufficient to compensate for signaling overheads of the central node.

An embodiment of this application provides a model training method 100. In the model training method 100, a first communication apparatus sends a first neural network parameter of the first communication apparatus. A second communication apparatus receives the first neural network parameter of the first communication apparatus, and the second communication apparatus sends first indication information to the first communication apparatus when a correlation coefficient between the first neural network parameter and a second neural network parameter of the second communication apparatus is less than a first threshold. The first indication information indicates that the second communication apparatus is to participate in training of a first neural network model of the first communication apparatus. In this way, the second communication apparatus receives the first indication information. When the correlation coefficient between the first neural network parameter and the second neural network parameter is less than the first threshold, the second communication apparatus feeds back to the first communication apparatus that the second communication apparatus is to participate in the training of the first neural network model. This can prevent the second communication apparatus from still participating in the training of the first neural network model when the correlation coefficient between the first neural network parameter and the second neural network parameter is equal to or greater than the first threshold, so that signaling overheads of the second communication apparatus can be reduced.

An embodiment of this application further provides a model training method 200. In the model training method 200, a first communication apparatus sends cooperation request information. The cooperation request information includes a plurality of training tasks, and the plurality of training tasks are obtained by splitting a to-be-trained neural network model by the first communication apparatus. A second communication apparatus receives the cooperation request information. The second communication apparatus sends second indication information when determining to participate in a first training task. The second indication information indicates that the second communication apparatus is to participate in training of the first training task, and the first training task is one or more of the plurality of training tasks. The first communication apparatus receives the second indication information from the second communication apparatus. It can be learned that the first communication apparatus splits the to-be-trained neural network model into the plurality of training tasks, and broadcasts the plurality of training tasks to each surrounding second communication apparatus by using the cooperation request information. The surrounding second communication apparatus feeds back the second indication information, to notify, by using the second indication information, the first communication apparatus of a training task in which the second communication apparatus can participate in training. In other words, each surrounding second communication apparatus assists in participating in training of the to-be-trained neural network model of the first communication apparatus, so that a requirement on a capability of the first communication apparatus can be reduced.

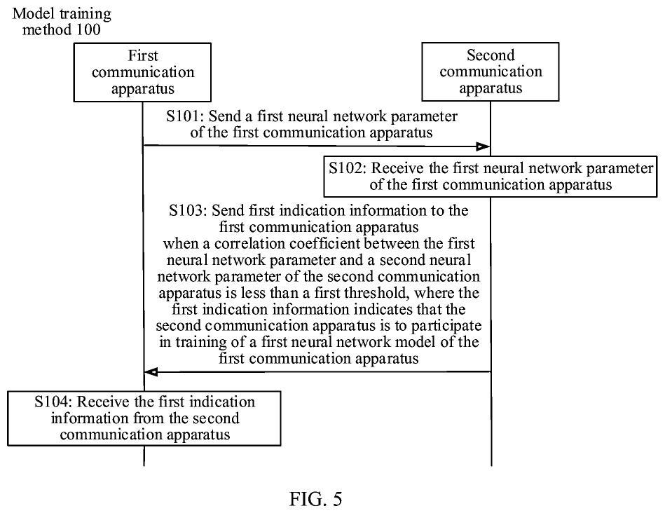

An embodiment of this application provides a model training method 100. FIG. 5 is a schematic flowchart of interaction of the model training method 100. The model training method 100 is described from a perspective of interaction between a first communication apparatus and a second communication apparatus. The model training method 100 includes but is not limited to the following steps.

S101: The first communication apparatus sends a first neural network parameter of the first communication apparatus.

It may be understood that the first neural network parameter is a neural network model, a gradient of a neural network, or may be training data for training the neural network model. To be specific, the first neural network parameter is a first neural network model of the first communication apparatus, a gradient of a first neural network, or training data for training the first neural network model. The neural network model includes a neuron included in the neural network and a weight between neurons at each layer.

In an optional implementation, the first communication apparatus trains the first neural network model based on a local dataset of the first communication apparatus. If the first neural network model still does not meet a preset convergence condition after a threshold quantity of rounds of training, the first communication apparatus may trigger a cooperation mechanism. That the first communication apparatus triggers the cooperation mechanism may include: The first communication apparatus sends a request message to a network device, to request the network device to configure, for the first communication apparatus, a related resource used for cooperative training. Optionally, the request message may be an on demand system information block (on demand system information block, on demand SIB). After receiving the request message from the first communication apparatus, the network device sends sidelink configuration information to the first communication apparatus and a surrounding device (each second communication apparatus) of the first communication apparatus.

The sidelink configuration information may be a SIB_AI_sidelink, and the sidelink configuration information is used to configure a cooperation synchronization resource, a cooperation discover resource, or a cooperation control resource. The cooperation synchronization resource may be an artificial intelligence cooperation synchronization (AI-cooperation-sync) resource, and the cooperation synchronization resource is used for synchronization between each second communication apparatus and the first communication apparatus. The cooperation discover resource may be an artificial intelligence cooperation discover (AI-cooperation-discover) resource, and the cooperation discover resource is used by the first communication apparatus to send the first neural network parameter, and is further used by the second communication apparatus to listen to the first neural network parameter of the first communication apparatus. The cooperation control resource may be an artificial intelligence cooperation control (AI-cooperation-control) resource, and the cooperation control resource is used by the first communication apparatus to indicate, to each second communication apparatus, a resource for sending a second neural network parameter.

Therefore, in this manner, the first neural network parameter is sent on the cooperation discover resource. For example, the first neural network parameter is sent by the first communication apparatus on the AI-cooperation-discover resource. The cooperation discover resource is configured in the foregoing sidelink configuration information.

In another optional implementation, when the first communication apparatus is a network device, the first communication apparatus may preconfigure the foregoing sidelink configuration information, and deliver the sidelink configuration information to each second communication apparatus.

In an optional implementation, before sending the first neural network parameter, the first communication apparatus may further send a synchronization signal on the foregoing cooperation synchronization resource, to enable the second communication apparatus to perform synchronization with the first communication apparatus based on the synchronization signal.

S102: The second communication apparatus receives the first neural network parameter of the first communication apparatus.

In an optional implementation, after receiving the request message from the first communication apparatus, the network device sends the sidelink configuration information to each second communication apparatus, so that the second communication apparatus receives the first neural network parameter on the cooperation discover resource configured in the foregoing sidelink configuration information.

In an optional implementation, before receiving the first neural network parameter, the second communication apparatus may further listen to the synchronization signal on the cooperation synchronization resource configured in the foregoing sidelink configuration information, and perform synchronization with the first communication apparatus based on the synchronization signal. Therefore, after completing the synchronization with the first communication apparatus, the second communication apparatus may communicate with the first communication apparatus, for example, receive the first neural network parameter from the first communication apparatus.

S103: The second communication apparatus sends first indication information to the first communication apparatus when a correlation coefficient between the first neural network parameter and the second neural network parameter of the second communication apparatus is less than a first threshold, where the first indication information indicates that the second communication apparatus is to participate in training of the first neural network model of the first communication apparatus.

It may be understood that when the foregoing first neural network parameter is a model parameter of the first neural network, the second neural network parameter is a model parameter of a second neural network, where the first neural network is a neural network of the first communication apparatus, and the second neural network is a neural network of the second communication apparatus. When the first neural network parameter is a gradient of the first neural network model, the second neural network parameter is a gradient of a second neural network model. When the first neural network parameter is the training data for training the first neural network model, the second neural network parameter is training data for training the second neural network model. A model parameter includes a neural network structure, a weight between neurons in the neural network structure, and the like.

The first threshold is preset by the second communication apparatus. The second neural network parameter of the second communication apparatus is a neural network parameter of a neural network model obtained by updating a local neural network model of the second communication apparatus based on the first neural network parameter after the second communication apparatus receives the first neural network parameter. Therefore, the second communication apparatus compares the neural network parameter of the updated neural network model with the first neural network parameter, to determine the correlation coefficient between the first neural network parameter and the second neural network parameter.

For example, the local neural network model before the second communication apparatus receives the first neural network parameter is a neural network model X. After receiving the first neural network parameter, the second communication apparatus updates the neural network model X based on the first neural network parameter, to obtain a neural network model Y. The neural network model Y is the second neural network model, and the second communication apparatus compares a neural network parameter of the neural network model Y with the first neural network parameter, to determine the correlation coefficient between the first neural network parameter and the second neural network parameter.

In addition, when the first neural network parameter and the second neural network parameter belong to different types, manners of determining the correlation coefficient between the first neural network parameter and the second neural network parameter are also different. With reference to the types to which the first neural network parameter and the second neural network parameter belong, the manners of determining the correlation coefficient between the first neural network parameter and the second neural network parameter are described as follows.

1. The first neural network parameter is the model parameter of the first neural network, and the second neural network parameter is the model parameter of the second neural network.

When the first neural network parameter is the model parameter of the first neural network, and the second neural network parameter is the model parameter of the second neural network, the correlation coefficient between the first neural network parameter and the second neural network parameter is determined based on a first parameter and a second parameter. The first parameter is a parameter output by the first neural network model when the second communication apparatus inputs training data into the first neural network model. The first neural network model is determined based on the model parameter of the first neural network. The second parameter is a parameter output by the second neural network model of the second communication apparatus when the second communication apparatus also inputs the training data into the second neural network model.

To be specific, after receiving the first neural network parameter, the second communication apparatus determines the first neural network model based on the model parameter of the first neural network, then determines the first parameter and the second parameter based on the first neural network model and the second neural network model, and determines the correlation coefficient between the first neural network parameter and the second neural network parameter based on the first parameter and the second parameter. The first parameter and the second parameter are parameters respectively output by the first neural network model and the second neural network model when the second communication apparatus inputs same training data into the first neural network model and the second neural network model.

In a possible implementation, the second communication apparatus uses a result obtained by dividing a covariance between the first parameter and the second parameter by a product of a standard deviation of the first parameter and a standard deviation of the second parameter as an evaluation criterion for a correlation between the first neural network parameter and the second neural network parameter. For example, when the second communication apparatus inputs the same training data into the first neural network model and the second neural network model, the first neural network model and the second neural network model output X and Y respectively. To be specific, X is the first parameter, and Y is the second parameter. In this case, the correlation coefficient between the first neural network parameter and the second neural network parameter is:

$$ρ = \frac{Cov ( X , Y )}{{σ}_{X} {σ}_{Y}} \qquad ( 1 )$$

Cov(X, Y) represents a covariance between X and Y, and σₓ and σ_{y} represent standard deviations of X and Y respectively.

2. The first neural network parameter is the gradient of the first neural network model, and the second neural network parameter is the gradient of the second neural network model. Alternatively, the first neural network parameter is the training data for training the first neural network model, and the second neural network parameter is the training data for training the second neural network model.

When the first neural network parameter is the gradient of the first neural network model, and the second neural network parameter is the gradient of the second neural network model, the correlation coefficient between the first neural network parameter and the second neural network parameter is determined based on probability distribution of the gradient of the first neural network model and probability distribution of the gradient of the second neural network model. When the first neural network parameter is the training data for training the first neural network model, and the second neural network parameter is the training data for training the second neural network model, the correlation coefficient between the first neural network parameter and the second neural network parameter is determined based on probability distribution of the training data for training the first neural network model and probability distribution of the training data for training the second neural network model.

In a possible implementation, the correlation coefficient between the first neural network parameter and the second neural network parameter is determined based on probability distribution of the first neural network parameter, probability distribution of the second neural network parameter, and a definition of a Hellinger distance (Hellinger distance). To be specific, the correlation coefficient between the first neural network parameter and the second neural network parameter is:

$$H ( S ( {Z}_{a} ) , S ( {Z}_{b} ) ) = \frac{1}{2} ‖ \sqrt{S ( {Z}_{a} )} - \sqrt{S ( {Z}_{b} )} ‖ \qquad ( 2 )$$

Zₐ and Z_{b} respectively represent the first neural network parameter and the second neural network parameter, and S(Zₐ) and S(Z_{b}) respectively represent the probability distribution of the first neural network parameter and the probability distribution of the second neural network parameter.

It may be understood that, if the correlation coefficient between the first neural network parameter and the second neural network parameter is less than the first threshold, it means that the correlation between the second neural network parameter and the first neural network parameter is high. Therefore, the second neural network parameter makes a great contribution to convergence of the first neural network model. In other words, the second communication apparatus determines, based on the contribution of the second neural network parameter to the convergence of the first neural network model, whether to participate in the training of the first neural network model. When the second neural network parameter makes a great contribution to the convergence of the first neural network model, the second communication apparatus determines to participate in the training of the first neural network model, and notifies the first communication apparatus by using the first indication information. In this way, the second communication apparatus can be prevented from still participating in the training of the first neural network model when the contribution of the second neural network parameter to the convergence of the first neural network model is low, so that signaling overheads of the second communication apparatus can be reduced. In other words, unnecessary transmission overheads of the first communication apparatus are reduced.

In an optional implementation, a cooperation response resource used by the second communication apparatus to send the first indication information is further configured in the foregoing sidelink configuration information, so that the second communication apparatus sends the first indication information to the first communication apparatus on the cooperation response resource.

In another optional implementation, the second communication apparatus may further send the first indication information to the first communication apparatus on the foregoing cooperation control resource.

In still another optional implementation, the second communication apparatus sends fifth indication information to the first communication apparatus when the correlation coefficient between the first neural network parameter and the second neural network parameter is equal to or greater than the first threshold. The fifth indication information indicates that the second communication apparatus is not to participate in the training of the first neural network model. In other words, when determining not to participate in the training of the first neural network model, the second communication apparatus indicates, to the first communication apparatus by using the fifth indication information, that the second communication apparatus is not to participate in the training of the first neural network model, so that the first communication apparatus learns that the second communication apparatus does not participate in this round of training of the neural network parameter.

In yet another optional implementation, the first communication apparatus and the second communication apparatus agree in advance that the second communication apparatus does not feed back any information to the first communication apparatus when the correlation coefficient between the first neural network parameter and the second neural network parameter is equal to or greater than the first threshold. In other words, the second communication apparatus does not perform any processing when determining not to participate in the training of the first neural network model in a current round. Therefore, when the first communication apparatus does not receive feedback information from the second communication apparatus within preset time, the first communication apparatus determines that the second communication apparatus does not participate in the current round of training of the first neural network model, so that system signaling overheads can be reduced.

When determining not to participate in the current round of training of the first neural network model, the second communication apparatus waits for the first communication apparatus to send a neural network parameter in a next round of training, and compares the neural network parameter with the neural network parameter of the local neural network model updated by the second communication apparatus again, to determine whether to participate in the next round of training.

S104: The first communication apparatus receives the first indication information from the second communication apparatus.

The first communication apparatus may receive the first indication information on the cooperation response resource configured in the foregoing sidelink configuration information, or may receive the first indication information on the foregoing cooperation discover resource. This is not limited in this embodiment of this application.

The first communication apparatus learns of, by receiving the first indication information, a second communication apparatus that is willing to participate in the training of the first neural network model, so that the first communication apparatus updates the first neural network model based on the second neural network parameter of the second communication apparatus that feeds back the first indication information. This facilitates reducing the signaling overheads of the second communication apparatus, that is, reducing transmission overheads of the second communication apparatus.

In an optional implementation, after learning of, by using the first indication information, the second communication apparatus that is willing to participate in the training of the first neural network model, the first communication apparatus sends a control signal to a second communication apparatus in this part. The control signal indicates a time-frequency resource, and the indicated time-frequency resource is used by the second communication apparatus to send the second neural network parameter.

A resource used by the first communication apparatus to send the control signal is a cooperation control resource, and the cooperation control resource is configured in the foregoing sidelink configuration information.

In other words, after determining the second communication apparatus that is willing to participate in the training of the first neural network model, the first communication apparatus sends the control signal to the second communication apparatus in this part, to indicate, to the second communication apparatus in this part, the time-frequency resource for sending the second neural network parameter, so that second communication apparatuses in this part send second neural network parameters to the first communication apparatus on time-frequency resources corresponding to the second communication apparatuses.

In an optional implementation, the time-frequency resource used by the second communication apparatus to send the second neural network parameter is dynamically scheduled by the network device for the first communication apparatus. The first communication apparatus schedules, by using the control signal, the time-frequency resource for the second communication apparatus that feeds back the first indication information. Time-frequency resources that are scheduled by the first communication apparatus for different second communication apparatuses are different. In this manner, each time the first communication apparatus dynamically schedules the time-frequency resource for the second communication apparatus that feeds back the first indication information, resource utilization may be high.

In another optional implementation, the time-frequency resource used by the second communication apparatus to send the second neural network parameter is semi-persistently configured by the network device for the first communication apparatus. The semi-persistent resource periodically appears, so that the first communication apparatus does not need to schedule the time-frequency resource for the second communication apparatus. However, the first communication apparatus still needs to indicate, by using the control signal, a semi-persistent resource in the second communication apparatus to the second communication apparatus that feeds back the first indication information, to activate the semi-persistent resource. Further, the second communication apparatus may send the second neural network parameter to the first communication apparatus by using the semi-persistent resource. In this manner, the first communication apparatus does not need to schedule the time-frequency resource for the second communication apparatus, so that signaling overheads can be reduced.

In an optional implementation, after receiving the foregoing control signal, the second communication apparatus sends the second neural network parameter to the first communication apparatus by using the time-frequency resource indicated by the control signal. In this way, the first communication apparatus receives the second neural network parameter from the second communication apparatus, and updates the first neural network model based on the second neural network parameter. It may be understood that the first communication apparatus receives second neural network parameters of a plurality of second communication apparatuses, and the plurality of second communication apparatuses are all second communication apparatuses that feed back the first indication information, so that the first communication apparatus updates the first neural network model based on a plurality of second neural network parameters.

It may be understood that, that the first communication apparatus updates the first neural network model based on the plurality of second neural network parameters means: The first communication apparatus performs average summation processing on each second neural network parameter to obtain a processed second neural network parameter, and then updates the first neural network model based on the processed second neural network parameter. If the updated first neural network model still does not converge, and a quantity of training times does not reach a threshold quantity of times, the first communication apparatus broadcasts a first neural network parameter of the updated first neural network model to each surrounding second communication apparatus, so that each second communication apparatus determines, again based on a local neural network parameter of the second communication apparatus and a received neural network parameter, whether to participate in a next round of training of the updated first neural network model.

As described above, the cooperation synchronization resource, the cooperation discover resource, and the cooperation control resource configured in the sidelink configuration information may be dynamically indicated by the network device after the network device receives the request message. Optionally, the cooperation synchronization resource, the cooperation discover resource, and the cooperation control resource configured in the sidelink configuration information may alternatively be preconfigured by the network device, or may be unlicensed spectrum resources. This is not limited in this embodiment of this application.

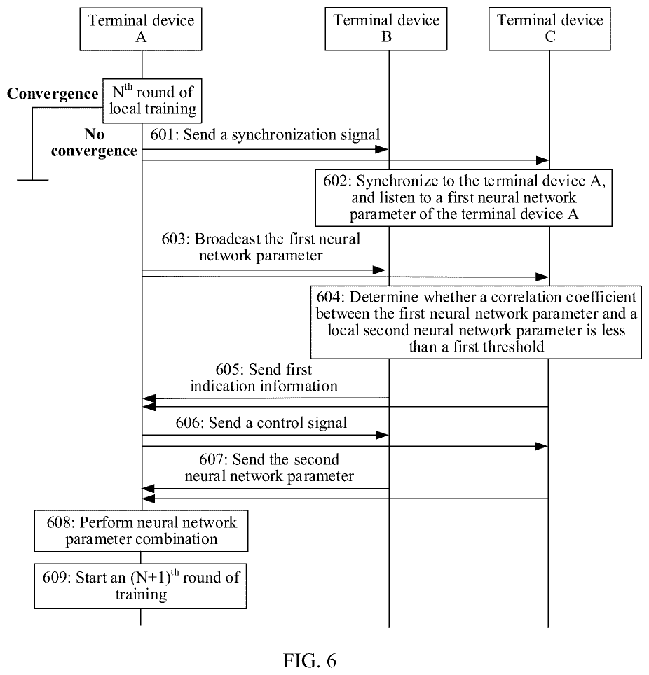

FIG. 6 is a schematic flowchart of interaction of a model training method in an example in which a first communication apparatus is a terminal device A and second communication apparatuses include a terminal device B and a terminal device C according to an embodiment of this application. As shown in FIG. 6:

601: If a first neural network model of the terminal device A has not converged after the terminal device A performs N rounds of training by using local training data, the terminal device A sends a synchronization signal to surrounding terminal devices (the terminal device B and the terminal device C). Optionally, a value of N is less than a threshold quantity of times.

602: After obtaining the synchronization signal through listening, the terminal device B and the terminal device C separately perform synchronization with the terminal device A based on the synchronization signal, and then listen to a first neural network parameter of the terminal device A. The terminal device B and the terminal device C perform the synchronization with the terminal device A, to ensure that the terminal device B and the terminal device C can communicate with the terminal device A subsequently. Both a resource used by the terminal device A to send the synchronization signal and a resource used by the terminal device B and the terminal device C to listen to the synchronization signal may be cooperation synchronization resources configured in the foregoing sidelink configuration information. Details are not described again.

603: The terminal device A broadcasts the first neural network parameter of the terminal device A on the foregoing cooperation discover resource.

604: After obtaining the first neural network parameter on the cooperation discover resource through listening, the terminal device B and the terminal device C compare the first neural network parameter with second neural network parameters of the terminal device B and the terminal device C, to determine whether a correlation coefficient between the first neural network parameter and the second neural network parameter is less than a first threshold.

605: When the correlation coefficient between the first neural network parameter and the second neural network parameter is less than the first threshold, the terminal device B and the terminal device C send, to the terminal device A, first indication information indicating that the terminal device B and the terminal device C are to participate in training of the first neural network model.

606: After receiving the first indication information from the terminal device B and the terminal device C, the terminal device A sends a control signal to the terminal device B and the terminal device C, to respectively indicate, to the terminal device B and the terminal device C by using the control signal, time-frequency resources for sending the second neural network parameters of the terminal device B and the terminal device C.

607: The terminal device B and the terminal device C respectively send the second neural network parameters of the terminal device B and the terminal device C to the terminal device A based on the indicated time-frequency resources.

For example, a control signal #b sent by the terminal device A to the terminal device B indicates a time-frequency resource #b, and a control signal #c sent by the terminal device A to the terminal device C indicates a time-frequency resource #c. Therefore, the terminal device B sends the second neural network parameter of the terminal device B to the terminal device A on the time-frequency resource #b, and the terminal device C sends the second neural network parameter of the terminal device C to the terminal device A on the time-frequency resource #c.

608: After receiving the second neural network parameter from the terminal device B and the second neural network parameter from the terminal device C, the terminal device A combines the two second neural network parameters, to be specific, performs weighted averaging on the two neural network parameters, to obtain a global neural network parameter.

609: The terminal device A then starts an (N+1)^{th} round of training by using the global neural network parameter, to be specific, updates the first neural network model based on the global neural network parameter, to obtain the updated first neural network model.

If the updated first neural network model does not converge, and a quantity of training times does not reach the threshold quantity of times, the terminal device A broadcasts a first neural network parameter of the updated first neural network model, and the terminal device B and the terminal device C determine, again based on the received neural network parameter and local neural network parameters of the terminal device B and the terminal device C at this moment, whether to participate in a next round of training of the terminal device A until the neural network model of the terminal device A converges, or the quantity of training times reaches the threshold quantity of times.

It can be learned that in this embodiment of this application, the second communication apparatus compares a second neural network parameter of the second communication apparatus with a received first neural network parameter, and when a correlation coefficient between the first neural network parameter and the second neural network parameter is less than the first threshold, feeds back, to the first communication apparatus, the first indication information indicating that the second communication apparatus is to participate in the training of the first neural network model, so that the first communication apparatus may update the first neural network model based on the second neural network parameter of the second communication apparatus that feeds back the first indication information. That the correlation coefficient between the first neural network parameter and the second neural network parameter is less than the first threshold indicates that the second neural network parameter makes a great contribution to convergence of the first neural network model. Therefore, the second communication apparatus determines, based on a contribution of the second neural network parameter to the convergence of the first neural network model, whether to participate in the training of the first neural network model. This can prevent the second communication apparatus from still participating in the training of the first neural network model when the second neural network parameter makes a small contribution to the convergence of the first neural network model, so that signaling overheads of the second communication apparatus can be reduced. In addition, the first communication apparatus no longer updates the first neural network model based on second neural network parameters of all surrounding second communication apparatuses, but updates the first neural network model based on the second neural network parameter of the second communication apparatus that feeds back the first indication information, so that signaling overheads of the first communication apparatus can be reduced.

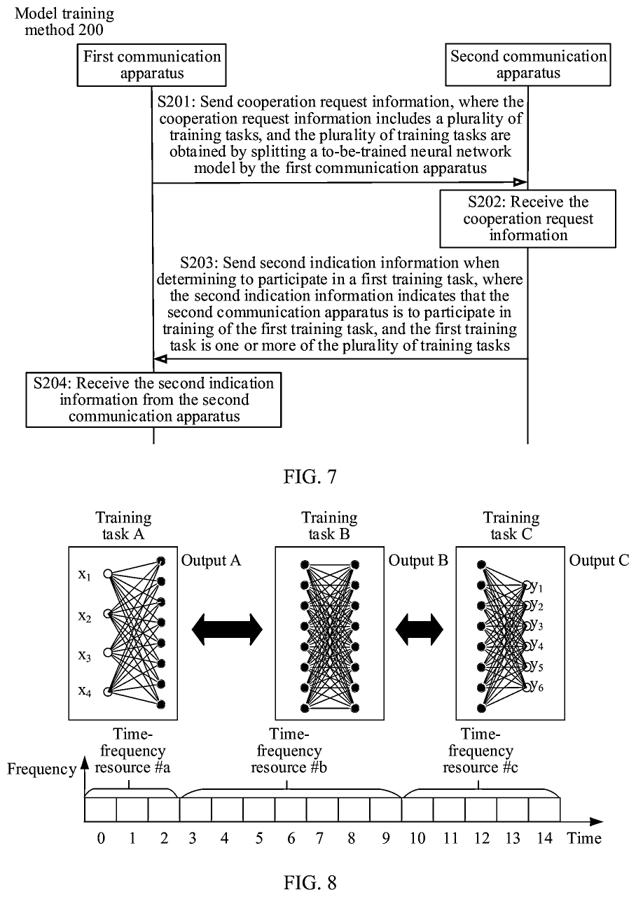

An embodiment of this application further provides a model training method 200. FIG. 7 is a schematic flowchart of interaction of the model training method 200. The model training method 200 is also described from a perspective of interaction between a first communication apparatus and a second communication apparatus. The model training method 200 includes but is not limited to the following steps.

S201: The first communication apparatus sends cooperation request information, where the cooperation request information includes a plurality of training tasks, and the plurality of training tasks are obtained by splitting a to-be-trained neural network model by the first communication apparatus.

It may be understood that, when a resource or a capability of the first communication apparatus is limited and the first communication apparatus cannot independently complete training of the to-be-trained neural network model, the first communication apparatus splits the to-be-trained neural network model into the plurality of training tasks, and broadcasts the plurality of training tasks to surrounding second communication apparatuses by using the cooperation request information, to request each second communication apparatus to assist the first communication apparatus in participating in training of the plurality of training tasks.

Each training task includes one simple neural network model, and each simple neural network model is a part of subnets of the to-be-trained neural network model.

In a possible implementation, the first communication apparatus splits the to-be-trained neural network model based on a delay of a subnet obtained through splitting. Optionally, the first communication apparatus splits the to-be-trained neural network model based on a computing capability of each second communication apparatus Optionally, the first communication apparatus splits the to-be-trained neural network model based on a data volume generated at a splitting location.

In an optional implementation, the first communication apparatus evenly splits the to-be-trained neural network model into a plurality of training tasks based on a structure of the to-be-trained neural network model, so that a to-be-trained neural network model included in each training task has a same quantity of neural network layers. The quantity of neural network layers included in each training task is not limited in this application.

For example, as shown in FIG. 8, the first communication apparatus splits the to-be-trained neural network model into three training tasks: a training task A, a training task B, and a training task C. The training task A, the training task B, and the training task C each include two layers of neural networks. The first communication apparatus uses the training task C as a training part of the first communication apparatus, uses the training task A and the training task B as two training tasks, and broadcasts the training task A and the training task B to the surrounding second communication apparatuses in a cooperation request manner.

In another optional implementation, the first communication apparatus splits the to-be-trained neural network model into a plurality of training tasks with uneven training degrees. In other words, each training task includes different quantities of neural network layers. Therefore, this facilitates that a second communication apparatus with a small quantity of remaining resources or a small computing capability participates in training of a training task with a small quantity of neural network layers, and facilitates that a second communication apparatus with a large quantity of remaining resources or a large computing capability participates in training of a training task with a large quantity of neural network layers.

In an optional implementation, when determining that training of the to-be-trained neural network model cannot be completed, the first communication apparatus sends a request message (for example, an on demand SIB) to a network device, to request the network device to configure, for the first communication apparatus, a related resource used for cooperative training. After receiving the request message from the first communication apparatus, the network device sends sidelink configuration information to the first communication apparatus and a surrounding device (each second communication apparatus) of the first communication apparatus.

For an implementation of the sidelink configuration information, refer to the foregoing descriptions in S101. Details are not described again.

Therefore, the cooperation request information may be sent on a cooperation discover resource configured in the sidelink configuration information.

In an optional implementation, the foregoing cooperation request information may further include estimated overheads corresponding to each training task, and the like, so that after receiving the cooperation request information, the second communication apparatus determines, based on a remaining resource situation of the second communication apparatus, whether the second communication apparatus can participate in training of some training tasks.

S202: The second communication apparatus receives the cooperation request information.

In an optional implementation, the network device sends the sidelink configuration information to the second communication apparatus, and the sidelink configuration information is configured with some cooperation discover resources used for receiving request information. Therefore, the second communication apparatus may receive the cooperation request information on the cooperation discover resource configured in the foregoing sidelink configuration information.

S203: The second communication apparatus sends second indication information when determining to participate in a first training task, where the second indication information indicates that the second communication apparatus is to participate in training of the first training task, and the first training task is one or more of the plurality of training tasks.

It may be understood that the second communication apparatus determines, based on a quantity of remaining resources of the second communication apparatus, the computing capability of the second communication apparatus, and the like, one or more training tasks that the second communication apparatus can participate in from the plurality of training tasks in the cooperation request information. Then, the second communication apparatus notifies, by using the second indication information, the first communication apparatus of the first training task that the second communication apparatus can participate in. The first training task includes one or more training tasks that can be trained by the second communication apparatus.

In an optional implementation, the first communication apparatus and each second communication apparatus agree in advance that, after receiving the cooperation request information, if the second communication apparatus feeds back, to the first communication apparatus, a training task that can be participated in, the second communication apparatus feeds back one training task in which the second communication apparatus can participate in training. To be specific, when the second communication apparatus can participate in training of one or more training tasks, the second communication apparatus feeds back one of the one or more training tasks to the first communication apparatus by using the second indication information. In other words, the first training task includes one of the plurality of training tasks carried in the cooperation request information.

In another optional implementation, the first communication apparatus and each second communication apparatus agree in advance that, after receiving the cooperation request information, if the second communication apparatus feeds back, to the first communication apparatus, a training task that can be participated in, the second communication apparatus may feed back all training tasks in which the second communication apparatus can participate in training. To be specific, the second communication apparatus may feed back, to the first communication apparatus by using the second indication information, all the training tasks in which the second communication apparatus can participate in training. In other words, the first training task includes one or more of the plurality of training tasks carried in the cooperation request information.

S204: The first communication apparatus receives the second indication information from the second communication apparatus.

It may be understood that the first communication apparatus learns of, by receiving the second indication information from the second communication apparatus, a second communication apparatus that is willing to participate in training and a training task that each second communication apparatus can participate in.

It can be learned from S203 that the second communication apparatus feeds back, to the first communication apparatus, one training task that can be participated in, or feeds back all training tasks that can be participated in.

When each second communication apparatus feeds back one training task that can be participated in, training tasks fed back by some second communication apparatuses may be a same training task. The first communication apparatus needs to determine, from a plurality of second communication apparatuses that feed back a same training task, a second communication apparatus that trains the same training task. It may be understood that the first communication apparatus determines, in a negotiation manner or based on remaining resources or computing capabilities of the plurality of second communication apparatuses, quality of a channel between each second communication apparatus and the first communication apparatus, or the like, one second communication apparatus that participates in the same training task, and sends third indication information to the determined second communication apparatus, to notify the second communication apparatus that training of a training task indicated by the third indication information can be performed.

That the first communication apparatus uses the negotiation manner may mean that the first communication apparatus negotiates with the plurality of second communication apparatuses, to determine that a second communication apparatus closest to the first communication apparatus participates in training of the same training task. A specific negotiation manner is not limited in this embodiment of this application.

For example, that the first communication apparatus determines, based on a computing capability of each of the plurality of second communication apparatuses, a second communication apparatus that participates in the training of the same training task may mean that the first communication apparatus determines that a second communication apparatus with a largest computing capability in the plurality of second communication apparatuses participates in the training of the same training task, to ensure that the same training task is completely trained.

For example, the cooperation request information sent by the first communication apparatus carries the training task A and the training task B, and surrounding second communication apparatuses A, B, and C all receive the cooperation request information. Second indication information sent by the second communication apparatus A indicates the training task A, and second indication information sent by the second communication apparatus B and the second communication apparatus C both indicates the training task B. It can be learned that the second communication apparatus B and the second communication apparatus C feed back a same training task. In this case, the first communication apparatus needs to determine, from the second communication apparatus B and the second communication apparatus C, one second communication apparatus that performs training of the training task B. If the first communication apparatus determines, in a manner of negotiating with the second communication apparatus B and the second communication apparatus C, that the second communication apparatus B is enabled to participate in the training of the training task B, the first communication apparatus sends third indication information to the second communication apparatus B, where the third indication information indicates the training task B. Therefore, after receiving the third indication information, the second communication apparatus B may perform the training of the training task B.

For example, the cooperation request information sent by the first communication apparatus carries the training task A and the training task B, and the surrounding second communication apparatuses A, B, and C all receive the cooperation request information. The second indication information sent by the second communication apparatus A indicates the training task A and the training task C, and the second indication information sent by the second communication apparatus B and the second communication apparatus C both indicates the training task B. In this case, the first communication apparatus determines that the second communication apparatus A participates in training of the training task A and the training task C, and determines, in the negotiation manner, that the second communication apparatus C participates in the training of the training task B. Therefore, third indication information sent by the first communication apparatus to the second communication apparatus A indicates the training task A and the training task C, and third indication information sent to the second communication apparatus C indicates the training task B.

Optionally, when each second communication apparatus feeds back one training task that can be participated in, and each second communication apparatus feeds back a different training task, the first communication apparatus also sends the third indication information to each second communication apparatus that feeds back the second indication information. The third indication information indicates a training task fed back by the second communication apparatus, to notify each second communication apparatus that feeds back the second indication information that training of the training task can be performed.

In another optional implementation, the second communication apparatus feeds back, to the first communication apparatus, all training tasks in which the second communication apparatus can participate in training. In this case, the first communication apparatus determines, based on a training task in which each second communication apparatus can participate in training, a training task that each communication apparatus needs to participate in, and notifies, by using the third indication information, each second communication apparatus of the training task that each second communication apparatus needs to participate in. In other words, the first communication apparatus sends the third indication information to each second communication apparatus, where the third indication information indicates one training task in the first training task.

For example, the cooperation request information sent by the first communication apparatus carries the training task A, the training task B, and the training task C, and the surrounding second communication apparatuses A, B, and C all receive the cooperation request information. The second indication information sent by the second communication apparatus A indicates the training task C, the second indication information sent by the second communication apparatus B indicates the training task B, and the second indication information sent by the second communication apparatus C indicates the training task A and the training task B. Therefore, the first communication apparatus determines that the second communication apparatus can participate in training of the training task A. Further, the third indication information sent by the first communication apparatus to the second communication apparatus A indicates the training task C, the third indication information sent by the first communication apparatus to the second communication apparatus B indicates the training task B, and the third indication information sent by the first communication apparatus to the second communication apparatus C indicates the training task A.

For example, the cooperation request information sent by the first communication apparatus carries the training task A, the training task B, and the training task C, and the surrounding second communication apparatuses A, B, and C all receive the cooperation request information. The second indication information sent by the second communication apparatus A indicates the training task A and the training task C, the second indication information sent by the second communication apparatus B indicates the training task B, and the second indication information sent by the second communication apparatus C indicates the training task A and the training task B. The second communication apparatus determines, based on training tasks that can be participated in by the second communication apparatus A, the second communication apparatus B, and the second communication apparatus C respectively, that the second communication apparatus A can participate in training of the training task C, the second communication apparatus B can participate in training of the training task B, and the second communication apparatus C can participate in training of the training task A. Therefore, the third indication information sent by the first communication apparatus to the second communication apparatus A indicates the training task C, the third indication information sent by the first communication apparatus to the second communication apparatus B indicates the training task B, and the third indication information sent by the first communication apparatus to the second communication apparatus C indicates the training task A.

It can be learned that each second communication apparatus that is willing to participate in a training task learns of, by using the third indication information, a training task that needs to be trained by the second communication apparatus. Therefore, the second communication apparatus in this part trains a corresponding neural network model based on local training data, and stops training the neural network model when the first communication apparatus determines that the neural network model converges. It may be understood that the first communication apparatus determines, through an input and output of the to-be-trained neural network model, whether the neural network model converges.

For example, the first communication apparatus splits the to-be-trained neural network model into the three training tasks shown in FIG. 8, and the first communication apparatus performs the training of the training task C. In other words, the first communication apparatus performs training of a subnet that includes an output of a neural network. Therefore, the first communication apparatus negotiates with each second communication apparatus about an input (X) of a neural network, and determines, through an output (an output of the neural network) Y of the training task C trained by the first communication apparatus, whether neural network models trained by the first communication apparatus and each second communication apparatus converge.

In an optional implementation, after determining a training task that each of second communication apparatuses that feed back the second indication information participates in, the first communication apparatus sends fourth indication information to each second communication apparatus. The fourth indication information indicates a first output that needs to be received by the second communication apparatus, and a time-frequency resource location corresponding to the first output, and/or a second output that needs to be sent by the second communication apparatus, and a time-frequency resource location corresponding to the second output.

The first output is an output of a neural network model trained by the first communication apparatus, or an output of a neural network model trained by a second communication apparatus other than the second communication apparatus, and the second output is an output of a neural network model trained by the second communication apparatus.

It may be understood that the first communication apparatus indicates, by using the fourth indication information to each second communication apparatus participating in the training task, a parameter that needs to be received and/or a parameter that needs to be sent, and schedules, for each second communication apparatus, a time-frequency resource of the parameter that needs to be received and/or the parameter that needs to be sent, so that the second communication apparatus learns of time-frequency resources on which the second communication apparatus needs to receive and/or send which parameters.

For example, the first communication apparatus splits the to-be-trained neural network model into the training tasks shown in FIG. 8, the first communication apparatus performs the training of the training task A, the second communication apparatus A performs the training of the training task B, and the second communication apparatus B performs the training of the training task C. In this case, for the second communication apparatus A, the first output is an output (an output A) of the neural network model trained by the first communication apparatus, and the second output is an output (an output B) of a neural network model in the training task B trained by the second communication apparatus A. For the second communication apparatus B, the first output is the output (the output B) of the neural network model in the training task B trained by the second communication apparatus A, and the second output is an output (an output C) of a neural network model in the training task C trained by the second communication apparatus B.

The first communication apparatus determines that the first communication apparatus needs to send, on a time-frequency resource #a, an output of a neural network model in the training task A. In addition, the first communication apparatus indicates, to the second communication apparatus A by using the fourth indication information, that the second communication apparatus needs to receive the output A on some time-frequency resources in a time-frequency resource #b, and send the output B on the other time-frequency resources in the time-frequency resource #b, or the first communication apparatus indicates, to the second communication apparatus A by using the fourth indication information, that the second communication apparatus needs to receive the output A and send the output B on different frequency-domain resources corresponding to the time-frequency resource #b. The first communication apparatus indicates, to the second communication apparatus B by using the fourth indication information, that the second communication apparatus B needs to receive the output B on some time-frequency resources in a time-frequency resource #c, and send the output C on the other time-frequency resources in the time-frequency resource #c, or the first communication apparatus indicates, to the second communication apparatus B by using the fourth indication information, that the second communication apparatus B needs to receive the output B and send the output C on different frequency-domain resources corresponding to the time-frequency resource #c. It can be learned that the second communication apparatus A and the second communication apparatus B transmit training results of the second communication apparatus A and the second communication apparatus B in a time division manner.

In an optional implementation, a resource for sending the fourth indication information may be a cooperation control resource configured in the foregoing sidelink configuration information.

In another optional implementation, before sending the cooperation request information, the first communication apparatus sends a synchronization signal on a cooperation synchronization resource. Therefore, the second communication apparatus receives the synchronization signal on the cooperation synchronization resource, and performs synchronization with the first communication apparatus based on the synchronization signal, so that the second communication apparatus can subsequently communicate with the first communication apparatus. The cooperation synchronization resource is configured in the foregoing sidelink configuration information.

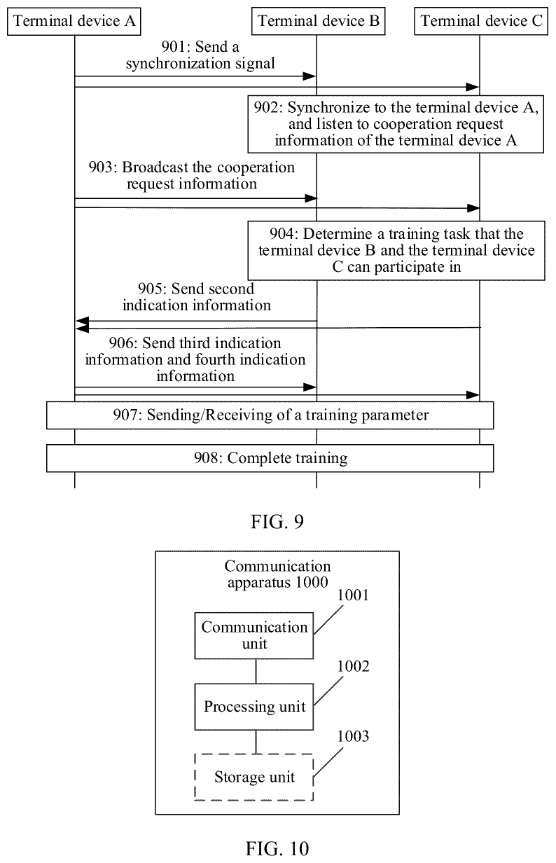

FIG. 9 is a schematic flowchart of interaction of another model training method in an example in which a first communication apparatus is a terminal device A and second communication apparatuses include a terminal device B and a terminal device C according to an embodiment of this application. As shown in FIG. 9:

901: If a terminal device determines that the terminal device cannot independently complete training of a to-be-trained neural network model, the terminal device A sends a synchronization signal to surrounding terminal devices (the terminal device B and the terminal device C).

902: After obtaining the synchronization signal through listening, the terminal device B and the terminal device C separately perform synchronization with the terminal device A based on the synchronization signal, and listen to cooperation request information of the terminal device A. The terminal device B and the terminal device C perform the synchronization with the terminal device A, to ensure that the terminal device B and the terminal device C can communicate with the terminal device A subsequently. Both a resource used by the terminal device A to send the synchronization signal and a resource used by the terminal device B and the terminal device C to listen to the synchronization signal may be cooperation synchronization resources configured in the foregoing sidelink configuration information. Details are not described again.

903: The terminal device A broadcasts the cooperation request information on the foregoing cooperation discover resource, to request the surrounding terminal device to assist in training of a plurality of training tasks.

904: After obtaining the cooperation request information on the cooperation discover resource through listening, the terminal device B and the terminal device C determine, based on remaining resource situations of the terminal device B and the terminal device C, one or more training tasks that the terminal device B and the terminal device C can participate in from the plurality of training tasks carried in the cooperation request information.

905: The terminal device B and the terminal device C send second indication information to the terminal device A, to feed back, to the terminal device A by using the second indication information, the one or more training tasks that the terminal device B and the terminal device C can participate in.

906: The terminal device A then determines, based on the training tasks that the terminal device B and the terminal device C can participate in, training tasks that the terminal device B and the terminal device C respectively need to participate in, and sends third indication information, to notify, by using the third indication information, the terminal device B and the terminal device C of the training tasks that the terminal device B and the terminal device C respectively need to participate in. In addition, the terminal device A sends fourth indication information to the terminal device B and the terminal device C, to notify the terminal device B and the terminal device C of parameters that need to be received and/or sent by the terminal device B and the terminal device C, and a time-frequency resource location corresponding to each parameter.

907: The terminal device B and the terminal device C train the training task indicated by the third indication information, and send or receive a corresponding parameter based on the time-frequency resource location of each parameter.

908: When determining that the neural network model converges, the terminal device A determines that training of the neural network model is completed.

In this embodiment of this application, the first communication apparatus splits the to-be-trained neural network model into a plurality of simple neural network models, that is, a plurality of training tasks, and broadcasts the plurality of training tasks to surrounding second communication apparatuses by broadcasting the cooperation request information. After receiving the plurality of training tasks, the second communication apparatus determines, based on a remaining amount of resources of the second communication apparatus, a training task that can be participated in. The second communication apparatus indicates, to the first communication apparatus by using the second indication information, the training task that the second communication apparatus can participate in. Therefore, the first communication apparatus determines a training task of each second communication apparatus based on a training task that each second communication apparatus can participate in, and notifies each second communication apparatus of the training task by using the third indication information. In this way, each second communication apparatus participating in cooperative training trains the training task indicated by the third indication information. One or more second communication apparatuses cooperate with the first communication apparatus to complete the training of the to-be-trained neural network model by training one or more of the plurality of training tasks carried in the cooperation request information, so that a requirement on a capability of the first communication apparatus can be reduced.

In this embodiment of this application, the training of the to-be-trained neural network model is completed without participation of a network device, but only with cooperative participation of the terminal devices. In addition, the first communication apparatus completes the training of the to-be-trained neural network model based on local data of the surrounding second communication apparatuses, so that the trained neural network model is more accurate.

To implement functions in the methods provided in embodiments of this application, the first communication apparatus or the second communication apparatus may include a hardware structure and/or a software module. The foregoing functions are implemented in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

As shown in FIG. 10, an embodiment of this application provides a communication apparatus 1000. The communication apparatus 1000 may be a component (for example, an integrated circuit or a chip) of a first communication apparatus, or may be a component (for example, an integrated circuit or a chip) of a second communication apparatus. Alternatively, the communication apparatus 1000 may be another communication unit, configured to implement the method in the method embodiments of this application. The communication apparatus 1000 may include a communication unit 1001 and a processing unit 1002. Optionally, the communication apparatus may further include a storage unit 1003.

In a possible design, one or more units in FIG. 10 may be implemented by one or more processors, may be implemented by one or more processors and memories, may be implemented by one or more processors and transceivers, or may be implemented by one or more processors, memories, and transceivers. This is not limited in this embodiment of this application. The processor, the memory, and the transceiver may be disposed separately, or may be integrated.

The communication apparatus 1000 has a function of implementing the second communication apparatus described in embodiments of this application. Optionally, the communication apparatus 1000 has a function of implementing the first communication apparatus described in embodiments of this application. For example, the communication apparatus 1000 includes a module, a unit, or a means (means) corresponding to performing the steps related to the second communication apparatus in embodiments of this application by the second communication apparatus. The function, the unit, or the means (means) may be implemented by software, or may be implemented by hardware, or may be implemented by hardware executing corresponding software, or may be implemented in a combination of software and hardware. For details, further refer to the corresponding descriptions in the foregoing corresponding method embodiments.

In a possible design, one communication apparatus 1000 may include a processing unit 1002 and a communication unit 1001. The processing unit 1002 is configured to control the communication unit 1001 to receive and send data/signaling.

The communication unit 1001 is configured to receive a first neural network parameter of the first communication apparatus.

The communication unit 1001 is further configured to send first indication information to the first communication apparatus when a correlation coefficient between the first neural network parameter and a second neural network parameter of the apparatus is less than a first threshold.

The first indication information indicates that the apparatus is to participate in training of a first neural network model of the first communication apparatus.

In an optional implementation, the first neural network parameter is a model parameter of a first neural network or a gradient of the first neural network, and the second neural network parameter is a model parameter of a second neural network or a gradient of the second neural network.

In an optional implementation, the first neural network parameter is received on a cooperation discover resource, and the cooperation discover resource is configured in sidelink configuration information.

In an optional implementation, when the correlation coefficient is less than the first threshold, the communication unit 1001 is further configured to send the second neural network parameter to the first communication apparatus.

In another optional implementation, the communication unit 1001 is further configured to receive a control signal from the first communication apparatus. The control signal indicates a time-frequency resource, and the indicated time-frequency resource is used by the apparatus to send the second neural network parameter.

In an optional implementation, a resource for receiving the control signal is a cooperation control resource, and the cooperation control resource is configured in the sidelink configuration information.

In an optional implementation, the communication unit 1001 is further configured to receive a synchronization signal on a cooperation synchronization resource. The processing unit 1002 is configured to perform synchronization with the first communication apparatus based on the synchronization signal. The cooperation synchronization resource is configured in the sidelink configuration information.

In an optional implementation, one or more of the cooperation discover resource, the cooperation control resource, and the cooperation synchronization resource configured in the sidelink configuration information are preconfigured, are dynamically indicated, or are unlicensed spectrum resources.

In an optional implementation, the first neural network parameter is the model parameter of the first neural network, and the second neural network parameter is the model parameter of the second neural network. The correlation coefficient between the first neural network parameter and the second neural network parameter is determined based on a first parameter and a second parameter. The first parameter is a parameter output by the first neural network model when the second communication apparatus inputs training data into the first neural network model. The first neural network model is determined based on the model parameter of the first neural network. The second parameter is a parameter output by a second neural network model of the second communication apparatus when the second communication apparatus inputs the training data into the second neural network model.

In another optional implementation, the first neural network parameter is the gradient of the first neural network, and the second neural network parameter is the gradient of the second neural network. The correlation coefficient between the first neural network parameter and the second neural network parameter is determined based on probability distribution of the first neural network parameter and probability distribution of the second neural network parameter.

This embodiment of this application and the foregoing method embodiments are based on a same concept, and bring a same technical effect. For a specific principle, refer to the descriptions of the foregoing embodiments. Details are not described again.

In another possible design, one communication apparatus 1000 may include a processing unit 1002 and a communication unit 1001. The processing unit 1002 is configured to control the communication unit 1001 to receive and send data/signaling.

The communication unit 1001 is configured to send a first neural network parameter of the apparatus.

The communication unit 1001 is further configured to receive first indication information from the second communication apparatus.

The first indication information is sent by the second communication apparatus when the correlation coefficient between the first neural network parameter and the second neural network parameter of the second apparatus is less than the first threshold.

The first indication information indicates that the second communication apparatus is to participate in training of a first neural network model of the apparatus.

In an optional implementation, the first neural network parameter is a model parameter of a first neural network or a gradient of the first neural network, and the second neural network parameter is a model parameter of a second neural network or a gradient of the second neural network.

In an optional implementation, the first neural network parameter is sent on a cooperation discover resource, and the cooperation discover resource is configured in sidelink configuration information.

In another optional implementation, the communication unit 1001 is further configured to receive a second neural network parameter from the second communication apparatus, and the processing unit 1002 is configured to update the first neural network model based on the second neural network parameter.

In still another optional implementation, the communication unit 1001 is further configured to send a control signal to the second communication apparatus. The control signal indicates a time-frequency resource, and the indicated time-frequency resource is used by the second communication apparatus to send the second neural network parameter.

In an optional implementation, a resource for sending the control signal is a cooperation control resource, and the cooperation control resource is configured in the sidelink configuration information.

In an optional implementation, the communication unit 1001 is further configured to send a synchronization signal on a cooperation synchronization resource, and the cooperation synchronization resource is configured in the sidelink configuration information.

In an optional implementation, one or more of the cooperation discover resource, the cooperation control resource, and the cooperation synchronization resource configured in the sidelink configuration information are preconfigured, are dynamically indicated, or are unlicensed spectrum resources.

This embodiment of this application and the foregoing method embodiments are based on a same concept, and bring a same technical effect. For a specific principle, refer to the descriptions of the foregoing embodiments. Details are not described again.

In still another possible design, one communication apparatus 1000 may include a processing unit 1002 and a communication unit 1001. The processing unit 1002 is configured to control the communication unit 1001 to receive and send data/signaling.

The communication unit 1001 is configured to send cooperation request information. The cooperation request information includes a plurality of training tasks, and the plurality of training tasks are obtained by splitting a to-be-trained neural network model by the first communication apparatus.

The communication unit 1001 is further configured to receive second indication information from the second communication apparatus. The second indication information indicates that the second communication apparatus is to participate in training of a first training task, and the first training task is one or more of the plurality of training tasks.

In an optional implementation, the foregoing cooperation request information is sent on a cooperation discover resource, and the cooperation discover resource is configured in sidelink configuration information.

In an optional implementation, the first training task indicated by the second indication information sent by the second communication apparatus includes a plurality of training tasks. In this case, the first communication apparatus may further send third indication information. The third indication information indicates one training task in the first training task.

In another optional implementation, first training tasks indicated by second indication information sent by a plurality of second communication apparatuses are same training tasks in the plurality of training tasks. In this case, the first communication apparatus may alternatively indicate, to one of the second communication apparatuses by using the third indication information, a training task that is participated in training.

In an optional implementation, the first communication apparatus may further send fourth indication information to the second communication apparatus. The fourth indication information indicates a first output that needs to be received by the second communication apparatus, and a time-frequency resource location corresponding to the first output, and/or a second output that needs to be sent by the second communication apparatus, and a time-frequency resource location corresponding to the second output. The first output is an output of a neural network model trained by the first communication apparatus, or an output of a neural network model trained by a second communication apparatus other than the second communication apparatus, and the second output is an output of a neural network model trained by the second communication apparatus.

In an optional implementation, a resource for sending the fourth indication information is a cooperation control resource, and the cooperation control resource is configured in the sidelink configuration information.

In an optional implementation, the first communication apparatus may further send a synchronization signal on a cooperation synchronization resource, to enable the second communication apparatus to perform synchronization with the first communication apparatus based on the synchronization signal. In addition, the cooperation synchronization resource is configured in the sidelink configuration information.

In an optional implementation, the cooperation discover resource, the cooperation control resource, and the cooperation synchronization resource configured in the foregoing sidelink configuration information are preconfigured, are dynamically indicated, or are unlicensed spectrum resources.

This embodiment of this application and the foregoing method embodiments are based on a same concept, and bring a same technical effect. For a specific principle, refer to the descriptions of the foregoing embodiments. Details are not described again.

In yet another possible design, one communication apparatus 1000 may include a processing unit 1002 and a communication unit 1001. The processing unit 1002 is configured to control the communication unit 1001 to receive and send data/signaling.

The communication unit 1001 is configured to receive cooperation request information. The cooperation request information includes a plurality of training tasks, and the plurality of training tasks are obtained by splitting a to-be-trained neural network model by the first communication apparatus.

The communication unit 1001 is further configured to send second indication information when determining to participate in training of a first training task. The second indication information indicates that the second communication apparatus is to participate in the training of the first training task, and the first training task is one or more of the plurality of training tasks.

In an optional implementation, the cooperation request information is received on a cooperation discover resource, and the cooperation discover resource is configured in sidelink configuration information.

In an optional implementation, the second communication apparatus may further receive third indication information. The third indication information indicates one training task in the first training task.

In an optional implementation, the second communication apparatus may further receive fourth indication information. The fourth indication information indicates a first output to be received by the second communication apparatus and a time-frequency resource location corresponding to the first output, and/or a second output to be sent by the second communication apparatus and a time-frequency resource location corresponding to the second output. The first output is an output of a neural network model trained by the first communication apparatus, or an output of a neural network model trained by a second communication apparatus other than the second communication apparatus, and the second output is an output of a neural network model trained by the second communication apparatus.

In an optional implementation, a resource for receiving the fourth indication information is a cooperation control resource, and the cooperation control resource is configured in the sidelink configuration information.

In an optional implementation, the second communication apparatus may further receive a synchronization signal on a cooperation synchronization resource, and perform synchronization with the first communication apparatus based on the synchronization signal.

In an optional implementation, the cooperation discover resource, the cooperation control resource, and the cooperation synchronization resource configured in the foregoing sidelink configuration information are preconfigured, are dynamically indicated, or are unlicensed spectrum resources.

This embodiment of this application and the foregoing method embodiments are based on a same concept, and bring a same technical effect. For a specific principle, refer to the descriptions of the foregoing embodiments. Details are not described again.

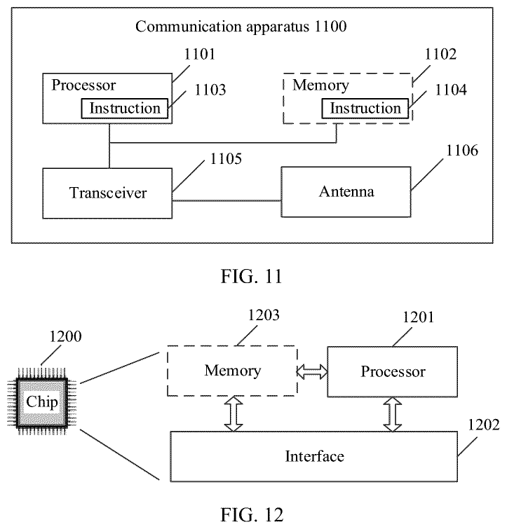

An embodiment of this application further provides a communication apparatus 1100. FIG. 11 is a schematic diagram of a structure of the communication apparatus 1100. The communication apparatus 1100 may be a first communication apparatus or a second communication apparatus, may be a chip, a chip system, a processor, or the like that supports the first communication apparatus in implementing the foregoing method, or may be a chip, a chip system, a processor, or the like that supports the second communication apparatus in implementing the foregoing method. The apparatus may be configured to implement the method described in the foregoing method embodiments. For details, refer to the descriptions in the foregoing method embodiments.

The communication apparatus 1100 may include one or more processors 1101. The processor 1101 may be a general-purpose processor, a dedicated processor, or the like. For example, the processor 1101 may be a baseband processor, a digital signal processor, an application-specific integrated circuit, a field programmable gate array or another programmable logic device, a discrete gate or a transistor logic device, a discrete hardware component, or a central processing unit (central processing unit, CPU). The baseband processor may be configured to process a communication protocol and communication data. The central processing unit may be configured to: control a communication apparatus (for example, a base station, a baseband chip, a terminal, a terminal chip, a distributed unit (distributed unit, DU), or a central unit (central unit, CU)), execute a software program, and process data of the software program.

Optionally, the communication apparatus 1100 may include one or more memories 1102. The memory 1102 may store an instruction 1104, and the instruction may be run on the processor 1101, so that the communication apparatus 1100 performs the method described in the foregoing method embodiments. Optionally, the memory 1102 may further store data. The processor 1101 and the memory 1102 may be disposed separately, or may be integrated together.

The memory 1102 may include but is not limited to a non-volatile memory such as a hard disk drive (hard disk drive, HDD) or a solid-state drive (solid-state drive, SSD), a random access memory (random access memory, RAM), an erasable programmable read-only memory (erasable programmable ROM, EPROM), a ROM, or a portable read-only memory (compact disc read-only memory, CD-ROM).

Optionally, the communication apparatus 1100 may further include a transceiver 1105 and an antenna 1106. The transceiver 1105 may be referred to as a transceiver unit, a transceiver, a transceiver circuit, or the like, and is configured to implement a transceiver function. The transceiver 1105 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function.

The communication apparatus 1100 is a second communication apparatus. The transceiver 1105 is configured to perform S102 and S103 in the foregoing model training method 100, and is configured to perform S202 and S203 in the model training method 200.

The communication apparatus 1100 is a second communication apparatus. The transceiver 1105 is configured to perform S101 and S104 in the model training method 100, and is configured to perform S201 and S204 in the model training method 200.

In another possible design, the processor 1101 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to perform signal transmission or transfer.

In still another possible design, optionally, the processor 1101 may store an instruction 1103, and the instruction 1103 is run on the processor 1101, so that the communication apparatus 1100 can perform the method described in the foregoing method embodiments. The instruction 1103 may be fixed in the processor 1101. In this case, the processor 1101 may be implemented by hardware.

In yet another possible design, the communication apparatus 1100 may include a circuit, and the circuit may implement a sending, receiving, or communication function in the foregoing method embodiments. The processor and the transceiver described in embodiments of this application may be implemented on an integrated circuit (integrated circuit, IC), an analog IC, a radio frequency integrated circuit (radio frequency integrated circuit, RFIC), a mixed-signal IC, an application-specific integrated circuit (application-specific integrated circuit, ASIC), a printed circuit board (printed circuit board, PCB), an electronic device, or the like. The processor and the transceiver may alternatively be manufactured by using various IC technologies, for example, a complementary metal oxide semiconductor (complementary metal oxide semiconductor, CMOS), an N-channel metal oxide semiconductor (nMetal-oxide-semiconductor, NMOS), a P-channel metal oxide semiconductor (positive channel metal oxide semiconductor, PMOS), a bipolar junction transistor (bipolar junction transistor, BJT), a bipolar CMOS (BiCMOS), silicon germanium (SiGe), and gallium arsenide (GaAs).

The communication apparatus described in the foregoing embodiments may be a first communication apparatus or a second communication apparatus. However, a scope of the communication apparatus described in embodiments of this application is not limited thereto, and a structure of the communication apparatus may not be limited by FIG. 11. The communication apparatus may be an independent device or may be a part of a large device. For example, the communication apparatus may be:
(1) an independent integrated circuit IC, a chip, or a chip system or subsystem;
(2) a set that has one or more ICs, where optionally, the IC set may alternatively include a storage component configured to store data and instructions;
(3) an ASIC, like a modem (modulator);
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) another device.

For a case in which the communication apparatus may be a chip or a chip system, refer to a schematic diagram of a structure of a chip shown in FIG. 12. The chip 1200 shown in FIG. 12 includes a processor 1201 and an interface 1202. There may be one or more processors 1201. There may be a plurality of interfaces 1202. The processor 1201 may be a logic circuit, and the interface 1202 may be an input/output interface, an input interface, or an output interface. The chip 1200 may further include a memory 1203.

In a design, when the chip is configured to implement a function of the second communication apparatus in embodiments of this application, the processor 1201 is configured to control the interface 1202 to perform output or receiving.

The interface 1202 is configured to receive a first neural network parameter of a first communication apparatus.

The interface 1202 is further configured to output first indication information when a correlation coefficient between the first neural network parameter and a second neural network parameter of the apparatus is less than a first threshold. The first indication information indicates that the apparatus is to participate in training of the first neural network model of the first communication apparatus.

In another design, when the chip is configured to implement a function of the first communication apparatus in embodiments of this application, the interface 1202 is configured to output a first neural network parameter of the apparatus.

The interface 1202 is further configured to receive first indication information from the second communication apparatus.

The first indication information is output by the second communication apparatus when a correlation coefficient between the first neural network parameter and a second neural network parameter of the second apparatus is less than a first threshold. The first indication information indicates that the second communication apparatus is to participate in training of a first neural network model of the apparatus.

In still another design, when the chip is configured to implement a function of the first communication apparatus in embodiments of this application, the interface 1202 is configured to output cooperation request information. The cooperation request information includes a plurality of training tasks, and the plurality of training tasks are obtained by splitting a to-be-trained neural network model by the first communication apparatus.

The interface 1202 is further configured to receive second indication information from the second communication apparatus. The second indication information indicates that the second communication apparatus is to participate in training of a first training task, and the first training task is one or more of the plurality of training tasks.

In yet another design, when the chip is configured to implement a function of the second communication apparatus in embodiments of this application, the interface 1202 is configured to receive cooperation request information. The cooperation request information includes a plurality of training tasks, and the plurality of training tasks are obtained by splitting a to-be-trained neural network model by the first communication apparatus.

The interface 1202 is further configured to output second indication information when determining to participate in training of a first training task. The second indication information indicates that the second communication apparatus is to participate in the training of the first training task, and the first training task is one or more of the plurality of training tasks.

In embodiments of this application, the communication apparatus 1100 and the chip 1200 may further perform the implementations of the foregoing communication apparatus 1000. A person skilled in the art may further understand that various illustrative logical blocks (illustrative logic blocks) and steps (steps) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the scope of embodiments of this application.

This embodiment of this application and the method embodiments shown in the model training method 100 and the model training method 200 are based on a same concept, and bring a same technical effect. For a specific principle, refer to the descriptions of the embodiments shown in the model training method 100 and the model training method 200. Details are not described again.

This application further provides a computer-readable storage medium, configured to store computer software instructions. When the instructions are executed by a communication apparatus, a function in any one of the foregoing method embodiments is implemented.

This application further provides a computer program product, configured to store computer software instructions. When the instructions are executed by a communication apparatus, a function in any one of the foregoing method embodiments is implemented.

This application further provides a computer program. When the computer program is run on a computer, a function in any one of the foregoing method embodiments is implemented.

This application further provides a communication system. The system includes at least one first communication apparatus and at least two second communication apparatuses in the foregoing aspects. In another possible design, the system may further include another device that interacts with the first communication apparatus and the second communication apparatus in the solutions provided in this application.

All or some of the foregoing embodiments may be implemented by using software, hardware, firmware, or any combination thereof. When the software is used to implement the embodiments, all or some of the embodiments may be implemented in a form of a computer program product. The computer program product includes one or more computer instructions. When the computer instructions are loaded and executed on a computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a high-density digital video disc (digital video disc, DVD)), a semiconductor medium (for example, an SSD), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A model training method, wherein the method comprises:
receiving, by a second communication apparatus, a first neural network parameter of a first communication apparatus; and
sending, by the second communication apparatus, first indication information to the first communication apparatus when a correlation coefficient between the first neural network parameter and a second neural network parameter of the second communication apparatus is less than a first threshold, wherein
the first indication information indicates that the second communication apparatus is to participate in training of a first neural network model of the first communication apparatus. 2 The method according to claim 1, wherein the first neural network parameter is a model parameter of a first neural network or a gradient of the first neural network, and the second neural network parameter is a model parameter of a second neural network or a gradient of the second neural network.

3. The method according to claim 1, wherein the first neural network parameter is received on a cooperation discover resource, and the cooperation discover resource is configured in sidelink configuration information.

4. The method according to claim 1, wherein when the correlation coefficient is less than the first threshold, the method further comprises:
sending, by the second communication apparatus, the second neural network parameter to the first communication apparatus.

5. The method according to claim 1, wherein the method further comprises:
receiving, by the second communication apparatus, a control signal from the first communication apparatus, wherein
the control signal indicates a time-frequency resource, and the indicated time-frequency resource is used by the second communication apparatus to send the second neural network parameter.

6. The method according to claim 5, wherein the control signal is received on a cooperation control resource, and the cooperation control resource is configured in the sidelink configuration information.

7. A communication apparatus, wherein the apparatus comprises:
a communication unit, configured to receive a first neural network parameter of a first communication apparatus, wherein
the communication unit is further configured to send first indication information to the first communication apparatus when a correlation coefficient between the first neural network parameter and a second neural network parameter of the apparatus is less than a first threshold; and
the first indication information indicates that the apparatus is to participate in training of a first neural network model of the first communication apparatus.

8. The apparatus according to claim 7, wherein the first neural network parameter is a model parameter of a first neural network or a gradient of the first neural network, and the second neural network parameter is a model parameter of a second neural network or a gradient of the second neural network.

9. The apparatus according to claim 7, wherein the first neural network parameter is received on a cooperation discover resource, and the cooperation discover resource is configured in sidelink configuration information.

10. The apparatus according to claim 7, wherein when the correlation coefficient is less than the first threshold, the communication unit is further configured to:
send the second neural network parameter to the first communication apparatus.

11. The apparatus according to claim 7, wherein the communication unit is further configured to:
receive a control signal from the first communication apparatus, wherein the control signal indicates a time-frequency resource, and the indicated time-frequency resource is used by the apparatus to send the second neural network parameter.

12. The apparatus according to claim 11, wherein the control signal is received on a cooperation control resource, and the cooperation control resource is configured in the sidelink configuration information.

13. The apparatus according to claim 7, wherein the apparatus further comprises a processing unit, wherein
the communication unit is further configured to receive a synchronization signal on a cooperation synchronization resource;
the processing unit is configured to perform synchronization with the first communication apparatus based on the synchronization signal; and
the cooperation synchronization resource is configured in the sidelink configuration information.

14. A communication apparatus, wherein the apparatus comprises:
a communication unit, configured to send a first neural network parameter of the apparatus, wherein
the communication unit is further configured to receive first indication information from a second communication apparatus;
the first indication information is sent by the second communication apparatus when a correlation coefficient between the first neural network parameter and a second neural network parameter of the second communication apparatus is less than a first threshold; and
the first indication information indicates that the second communication apparatus is to participate in training of a first neural network model of the apparatus.

15. The apparatus according to claim 14, wherein the first neural network parameter is a model parameter of a first neural network or a gradient of the first neural network, and the second neural network parameter is a model parameter of a second neural network or a gradient of the second neural network.

16. The apparatus according to claim 14, wherein the first neural network parameter is sent on a cooperation discover resource, and the cooperation discover resource is configured in sidelink configuration information.

17. The apparatus according to claim 14, wherein the apparatus further comprises a processing unit, wherein
the communication unit is further configured to receive the second neural network parameter from the second communication apparatus; and
the processing unit is configured to update the first neural network model based on the second neural network parameter.

18. The apparatus according to claim 14, wherein
the communication unit is further configured to send a control signal to the second communication apparatus, wherein
the control signal indicates a time-frequency resource, and the indicated time-frequency resource is used by the second communication apparatus to send the second neural network parameter.

19. The apparatus according to claim 18, wherein the control signal is sent on a cooperation control resource, and the cooperation control resource is configured in the sidelink configuration information.

20. The apparatus according to claim 14, wherein
the communication unit is further configured to send a synchronization signal on a cooperation synchronization resource, and the cooperation synchronization resource is configured in the sidelink configuration information.
